(19) United States
(12) Patent Application Publication
(10) Pub. No.: US 2012/0131196 A1
(43) Pub. Date: May 24, 2012

(54) COMPUTER SYSTEM MANAGEMENT APPARATUS AND MANAGEMENT METHOD

(75) Inventor: Tomoya Yamada, Fujisawa (JP)

(73) Assignee: Hitachi, Ltd.

(21) Appl. No.: 13/061,439

(22) PCT Filed: Nov. 18, 2010
(86) PCT No.: PCT/JP10/70625

§ 371 Date: Mar. 1, 2011

(51) Int. Cl. G06F 9/50

(52) U.S. Cl. 709/226

(57) ABSTRACT

The present invention manages response performance of a virtual volume. A performance monitoring server 10 monitors performance of a virtual volume 400, which a storage apparatus 40 provides to a host 30. When response performance of a virtual volume becomes lower than target performance, the performance monitoring server 10 creates and presents to a user either one or multiple solutions for improving the response performance. The user is able to issue an instruction based on the presented one or multiple solutions.

### TECHNICAL FIELD

The present invention relates to a computer system management apparatus and a management method.

### BACKGROUND ART

Storage virtualization technology, which creates a tiered pool using multiple types of storage apparatuses of respectively different performance and allocates an actual storage area stored in this tiered pool to a virtual logical volume (a virtual volume) in accordance with a write access from a host computer, is known (Patent Literature 1).

In the above-mentioned prior art, an actual storage area inside the pool is allocated to the virtual volume in page units. A storage apparatus regularly switches the storage device constituting the page destination in accordance with the number of I/O (inputs/outputs) of each page that has been allocated. For example, a page with a large number of I/Os is disposed in a high-performance storage device, and a page with a small number of I/Os is disposed in a low-performance storage device.

### CITATION LIST

### Patent Literature

### PTL 1

Japanese Patent Application Laid-open No. 2007-066259

### SUMMARY OF INVENTION

### Technical Problem

In the prior art, because an actual storage area inside the tiered pool is allocated to the virtual volume in page units, it is possible to reduce the capacity of the required high-performance storage device when designing a configuration that satisfies a performance condition and a capacity condition requested with respect to the virtual volume.

However, even though the performance condition related to the virtual volume was satisfied when the system was built, in accordance with yearly operations thereafter, there is the likelihood that the user-requested performance (SLA: Service Alliance Level) ceases to be met.

For example, since both the number of virtual volumes and the amount of data written by the host computer are small when the system is built, the actual storage area of the high-performance storage device is allocated to the virtual volume in page units. Therefore, the response time of the virtual volume is short and the user-requested performance is satisfied.

However, after the system has been operating for a long time, the number of virtual volumes increases, and, in addition, the amount of data written to each virtual volume also increases. When the system configuration changes like this, the high-performance pages (pages based on an actual storage area of a high-performance storage device) capable of being allocated to the virtual volume decrease.

In accordance with this, when the amount of data being written to the virtual volume increases once again, it becomes necessary to allocate a low-performance page (a page based on an actual storage area of a low-performance storage device). As a result of this, the average response time of the virtual volume drops, and the target performance value (SLA) configured by the user ceases to be satisfied.

When the response performance of the virtual volume declines, the user attempts to improve the virtual volume response performance by changing the system configuration. However, because the configuration of the computer system comprising the host computer and the storage apparatus becomes more complicated year after year, it is difficult for the inexperienced user to efficiently find a method for improving the response performance of the virtual volume, and user usability decreases.

With the foregoing problems in mind, one object of the present invention is to provide a computer system management apparatus and management method that enables virtual volume performance to be improved. Another object of the present invention is to provide a computer system management apparatus and management method that enables user usability to be enhanced by presenting a user with one or more useful solutions for improving virtual volume performance. Yet other objects of the present invention should become clear from the description of the embodiment explained hereinbelow.

### Solution to Problem

To solve for the above-mentioned problems, a computer system management apparatus related to the present invention is a management apparatus for managing a computer system comprising a host computer and a storage apparatus for providing multiple virtual volumes to the host computer, wherein the storage apparatus comprises multiple pools comprising multiple storage tiers of respectively different performance, and is configured so as to select an actual storage area of a prescribed size from within each of the storage tiers in accordance with a write access from the host computer, and to allocate the selected actual storage area to a write-accessed virtual volume of the respective virtual volumes.

The management apparatus includes: a problem detection part for detecting from among the respective virtual volumes a prescribed volume in which a performance problem has occurred; a solution detection part for detecting one or more solutions for solving the performance problem by controlling allocation of each of the actual storage areas of each of the storage tiers that is allocated to the prescribed volume; a presentation part for presenting to a user the detected one or more solutions; and a solution execution part for executing a solution selected by the user from among the presented one or more solutions.

The management apparatus may further include a microprocessor; a memory for storing a prescribed computer program that is executed by the microprocessor; and a communication interface circuit for the microprocessor to communicate with the host computer and the storage apparatus.

The problem detection part, the solution detection part, the presentation part, and the solution execution part may each be realized by the microprocessor executing the prescribed computer program.

The solution detection part is able to detect at least either one or both of a first solution or a second solution that has been prepared beforehand as the one or more solutions for solving the performance problem.

The first solution can be configured as a method by which actual storage areas belonging to a relatively high-performance storage tier are allocated in larger numbers than a current value to a prescribed volume by adding a new actual storage area to the relatively high-performance storage tier of multiple storage tiers that comprise a prescribed pool to which the prescribed volume belongs. The second solution can be configured as a method by which actual storage areas belonging to a relatively high-performance storage tier are allocated in larger numbers than a current value to a prescribed volume by migrating another virtual volume that belongs to the prescribed pool to another pool besides the prescribed pool of the respective pools.

In addition, the solution execution part can comprise a first execution part for executing the first solution, and a second execution part for executing the second solution.

The problem detection part is able to detect from among the respective virtual volumes a virtual volume that is not satisfying a preconfigured target performance value as the prescribed volume in which the performance problem has occurred.

The presentation part, in a case where the first solution is to be presented, may compute and present cost required for adding a new actual storage area to the relatively high-performance storage tier.

The present invention can also be understood as a management method for managing the computer system. In addition, at least a portion of the present invention may comprise a computer program. Also, multiple characteristic features of the present invention, which will be described in the embodiment, can be freely combined.

### BRIEF DESCRIPTION OF DRAWINGS

FIG. 1 is a schematic diagram showing an overview of the entire embodiment of the present invention.

FIG. 2 is a block diagram of a computer system.

FIG. 3 is a diagram schematically showing the relationship between a virtual volume and a pool.

FIG. 4 is an example of a screen that presents a user with measures for improving performance.

FIG. 5 is a screen that presents the user with a measure needed for changing a target performance value.

FIG. 6(a) shows a table for managing page performance, and FIG. 6(b) shows a table for managing a page configuration.

FIG. 7(a) shows a table for managing a pool, and FIG. 7(b) shows a table for managing the performance of a virtual volume.

FIG. 8(a) shows a table for managing a virtual volume configuration, and FIG. 8(b) shows a table for managing a target performance.

FIG. 9(a) shows a table for managing a storage device, and FIG. 9(b) shows a table for managing storage tiers in each pool.

FIG. 10 shows a table for managing a virtual volume in which a performance problem has occurred, and FIG. 10(b) shows a table for managing a candidate plan for adding storage capacity to each storage tier of the virtual volume.

FIG. 11(a) shows a table for managing a candidate plan for adding storage capacity to each storage tier of a pool, and FIG. 11(b) shows a table for managing a performance improvement measure.

FIG. 12(a) shows a table for managing a migration-candidate virtual volume, and FIG. 12(b) shows a table for managing a case where multiple migration-candidate virtual volumes are combined.

FIG. 13 shows a table for managing a migration pair.

FIG. 14 is a flowchart showing an overall process for managing the performance of a virtual volume.

FIG. 15 is a flowchart showing a process for acquiring information from the computer system.

FIG. 16 is a flowchart showing a process for detecting a virtual volume with a performance problem.

FIG. 17 is a flowchart showing a process for computing a page arrangement for each storage tier allocated to the virtual volume with the performance problem.

FIG. 18 is a flowchart showing a process for computing the arrangement of a new volume to be added to each storage tier of a pool.

FIG. 19 is a schematic diagram showing the relationship between allocated pages distributed inside a pool and a threshold between respective storage tiers.

FIG. 20 is a flowchart showing a process for registering a performance improvement measure in a table.

FIG. 21 is a flowchart showing a process for selecting a migration-candidate virtual volume.

FIG. 22 is a flowchart showing a process for selecting a pair of migration-candidate virtual volumes.

FIG. 23 is a flowchart showing a process for predicting the response time of a virtual volume in which a performance problem has occurred.

FIG. 24 is a flowchart showing a process for selecting a pool, which will become the migration-destination of the migration-target virtual volume.

FIG. 25 is a flowchart showing a process for predicting the response time of each virtual volume belonging to a migration destination-target pool in a case where a migration-target virtual volume has been migrated to this pool.

FIG. 26 is a flowchart related to a second example showing a process for configuring the target performance (the target response time) for a virtual volume.

FIG. 27 is a flowchart showing a process for detecting a measure required for configuring a target value.

FIG. 28 is a flowchart related to a third example showing a process for selecting a migration-candidate virtual volume by taking into account the presence or absence of a target performance setting.

FIG. 29 is a flowchart showing a process for selecting a migration-destination pool.

### DESCRIPTION OF EMBODIMENTS

An embodiment of the present invention will be explained below based on the drawings. In this embodiment, as will be explained hereinbelow, the page allocation of each storage tier allocated to a virtual volume is revised such that the performance of the virtual volume satisfies a target performance. In this embodiment, one or more solutions for solving a performance problem is detected by detecting from among the virtual volumes a prescribed volume in which a performance problem has occurred, and controlling the allocation of the respective actual storage areas of each storage tier that is allocated to the prescribed volume. In addition, in this embodiment, detected solutions are presented to a user, and a solution selected by the user from among the presented solutions is executed.

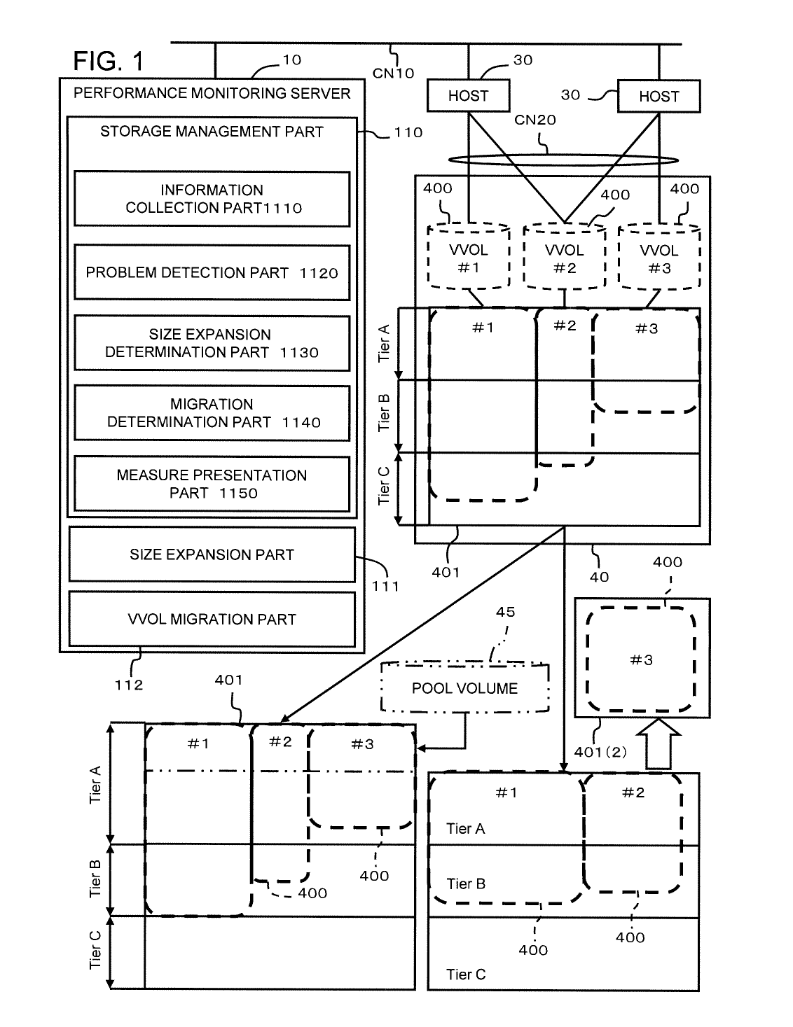

FIG. 1 shows an overview of this embodiment. The configuration will be described in more detail further below. A computer system, for example, comprises a performance monitoring server 10 that serves as the “management apparatus”, multiple host computers (hereinafter the host) 30, and one or more storage apparatuses 40.

The storage apparatus 40 provides the host 30 with a virtually created logical volume (hereinafter the virtual volume) 400. Only the size and access method of the virtual volume 400 are defined; the virtual volume 400 does not comprise an actual storage area for storing data.

The virtual volume 400 is associated with a pool 401. In brief, in a case where data is written to the virtual volume 400 from the host 30, a page selected from the pool 401 is allocated to the virtual volume 400. The data from the host 30 is written to the allocated page.

The pool 401 comprises multiple storage tiers with respectively different performance. In FIG. 1, three types of storage tiers are shown: Tier A, Tier B, and Tier C. Tier A serves as the “high-level storage tier,” and comprises an actual storage area of a highest-performance storage device. Tier B serves as the “mid-level storage tier,” and comprises an actual storage area of a medium-performance storage device. Tier C serves as the “low-level storage tier,” and comprises an actual storage area of a low-performance storage device.

In a case where data is written to an unallocated address area of a page inside the virtual volume 400, as described above, an actual storage area belonging to any of the storage tiers inside the pool 401 is selected in page units. The selected page is allocated to the write-target address area and stores the data.

The storage tier, which is the destination of the page that has been allocated to the virtual volume 400, is changed either regularly or irregularly based on this page's access-related information. For example, a high-frequency access page is moved to a higher performance storage tier. Alternatively, a low-frequency access page is moved a lower performance storage tier. In accordance with this, the response time for high-frequency access data is shortened. In addition, since low-frequency access data can be moved from a high-performance storage tier to a low-performance storage tier, the high-performance storage tier can be utilized efficiently.

For example, it will be assumed that only one virtual volume 400 (#1) was provided when the computer system was built. In accordance with this, a larger number of pages belonging to a high-level tier (will also be called the high-level page) and pages belonging to a mid-level tier (will also be called the mid-level page) are allocated to the virtual volume 400 (#1). A high-frequency access page belongs to the high-level tier, and a low-frequency access page belongs to the mid-level tier. Therefore, the average response time of the virtual volume 400 (#1) is relatively short.

The number of virtual volumes 400 will increase during the long-term operation of the computer system. In addition, the total amount of data written to each virtual volume 400 will also increase. As the number of pages allocated to each virtual volume 400 increases, free pages inside the high-level tier and the mid-level tier become scarce. Therefore, it becomes necessary to make use of a low-level tier page.

In FIG. 1, a page belonging to a low-level tier (will also be called a low-level page) is allocated to the virtual volume 400 (#1). In accordance with this, the average response time of the virtual volume 400 (#1) becomes longer. This is because this response time increases in a case where data being stored in the low-performance storage tier is accessed.

In a case where there is a free page in the high-level tier, medium-frequency access data can be moved to a high-level page. However, in a case where a free page does not exist in the high-level tier, even relatively high-frequency access data is unable to be stored in a high-level page. The relatively high-frequency access data is stored in a mid-level page. In accordance with this, there is the likelihood that the user-requested target performance (will also be called the target performance value, the target value, and the target response time) for the virtual volume 400 (#1) will not be able to be realized.

In a case where the situation becomes even worse, a portion of the relatively high-frequency access data could be disposed in a low-level page. In this case, the average response time of the virtual volume 400 (#1) becomes even longer.

The performance monitoring server 10 monitors the response performance of each virtual volume 400, and in a case where a virtual volume 400 in which a performance problem has occurred is discovered, at least one or more solutions to this problem are created and presented to the user.

The performance monitoring server 10 comprises a storage management part 110, a size expansion part 111, and a virtual volume migration part 112. There may be cases where virtual volume is abbreviated as “VVOL” in the drawings.

The storage management part 110, the size expansion part 111, and the virtual volume migration part 112, for example, can be created as software products such as computer programs. However, these parts 110, 111, and 112 are not limited to comprising software products, and at least a portion thereof may be created from a hardware circuit.

The storage management part 110 collects information from the host 30 and the storage apparatus 40, detects a performance problem in the storage apparatus 40, and creates a solution therefor. The storage management part 110, for example, comprises an information collection part 1110, a problem detection part 1120, a size expansion determination part 1130, a migration determination part 1140, and a measure presentation part 1150.

The information collection part 1110, briefly stated, collects and manages information from the storage apparatus 40 and the host 30. Specifically, the information collection part 1110 collects information from the storage apparatus 40 using a storage monitoring agent 210, which will be explained further below. In addition, the information collection part 1110 collects and manages host 30 information using a host monitoring agent 330 and an application monitoring agent 340, which will be explained further below.

The problem detection part 1120 detects from among the respective virtual volumes 400 a virtual volume for which a performance problem has occurred as a “problem volume” for which a solution for improving performance must be implemented. The problem volume corresponds to the “prescribed volume.”

“Performance problem” signifies that a preconfigured target performance value has not been met. For example, a target response time is configured in a virtual volume 400 as the target performance value. In a case where the actual response time of the virtual volume 400 is longer than the target response time, it is determined that a performance problem has occurred in this virtual volume 400. That is, the performance problem is a problem related to response performance.

The size expansion determination part 1130 and the migration determination part 1140 correspond to the “solution detection part”. The size expansion determination part 1130 makes a determination with respect to adding capacity to a pool 401 as the “first solution”. The migration determination part 1140 makes a determination with respect to moving another virtual volume 400 belonging to the pool 401 to another pool 401 (2) as the “second solution”.

The size expansion determination part 1130 computes the page allocation of the virtual volume in which the problem occurred (hereinafter will also be called the problem volume) 400, and computes the amount of pages to be added to the pool 401 in order for the problem volume to meet the target response time. For example, in a case where a new pool volume 45 is added to the high-level tier (Tier A) and the free high-level pages are increased, the number of high-level pages allocated to the problem volume also increases. In a case where the solution (will also be called a measure) devised by the size expansion determination part 1130 is executed, the average response time of the problem volume is shortened to equal to or less than the target response time.

As shown in the bottom left of FIG. 1, in a case where a high-performance pool volume is added to the high-level tier of pool 401, the size of the high-level tier is expanded. In accordance with this, of the respective data in the problem volume 400 (#1), data that had been stored in a page of the mid-level tier is disposed in a page of the high-level tier, and, in addition, data that had been disposed in a page of the low-level tier is disposed in a page of the mid-level tier. As a result, the average response time of the problem volume 400 (#1) is shortened to equal to or less than the target response time.

High-level tier pages and mid-level tier pages are also allocated in larger numbers than the current value to the other virtual volumes 400 (#2) and 400 (#3), in which performance problems have not occurred, the same as the problem volume 400 (#1). Therefore, the average response times of each of the other virtual volumes 400 (#2) and 400 (#3), in which problems have not occurred, also become shorter. That is, in a case where a new pool volume 45 is added to the high-level tier of the pool 401 and the free area of the high-level tier is expanded, the response performance of all the virtual volumes that belong to this pool 401 is improved.

The migration determination part 1140 makes a determination with respect to moving another virtual volume 400 belonging to the pool 401 to another pool 401 (2) to increase the free area in the pool 401 to which the problem pool belongs. For example, in the FIG. 1, in a case where 400 (#1) is regarded as the problem volume, the migration determination part 1140 creates a plan (a solution) for moving either any one or both of the other virtual volumes 400 (#2) and 400 (#3) belonging to the pool 401 to the other pool 401 (2).

The bottom right of FIG. 1 shows how the virtual volume 400 (#3) is selected as the migration-target volume, and moved from the migration-source pool 401 to the migration-destination pool 401 (2). The other pool 401 (2) may exist inside the same storage apparatus 40 as the migration-source pool 401, or may exist in a different storage apparatus than the storage apparatus 40 to which the migration-source pool 401 belongs.

In a case where the solution created by the migration determination part 1140 is executed, each page of each storage tier allocated to the virtual volume 400 (#3), which is the migration-target volume, becomes reusable as a free page. The migration of the virtual volume 400 (#3) to the other pool 401 (2) increases the free area in the pool 401. In accordance with this, it becomes possible to allocate a larger number of high-level tier pages to the problem volume 400 (#1). As a result of this, the response time of the problem volume 400 (#1) drops down to equal to or less than the target response time configured in the problem volume 400 (#1).

Furthermore, in a case where the virtual volume 400 (#3), in which a performance problem has not occurred, is migrated to the other pool 401 (2), the change in the response time of the migration-destination pool 401 (2) must be taken into consideration.

The measure presentation part 1150, which serves as the “presentation part”, presents the user with a solution that was created by the size expansion determination part 1130 and/or the migration determination part 1140. The size expansion determination part 1130 and/or the migration determination part 1140 can also both create multiple solutions.

The measure presentation part 1150 can present the user with both multiple solutions created by the size expansion determination part 1130 and other multiple solutions created by the migration determination part 1140.

The measure presentation part 1150 can also combine a solution created by the size expansion determination part 1130 with a solution created by the migration determination part 1140 and present this combined solution to the user. For example, the measure presentation part 1150 can present the user with a composite proposal such as migrate another virtual volume 400 (#3) of the pool 401 to another pool 401 (2), and, in addition, add a pool volume 45 to the high-level tier of the pool 401.

In addition, the measure presentation part 1150 can also compute both the cost of adding a new storage area (a new pool volume) to the pool 401 and the cost of increasing the free area by migrating another virtual volume inside the pool 401, and present these cost computations to the user. The user selects any one or multiple solutions from among the presented solutions.

A size expansion part 111, which serves as the “first execution part”, receives an execution instruction from the user and adds a new pool volume to the pool 401. A virtual volume migration part 112, which serves as the “second execution part”, receives an execution instruction from the user and migrates a virtual volume that belongs to the pool 401 shared in common with the problem volume to another pool 401 (2).

Configuring this embodiment like this makes it possible to create a solution for the response performance of each virtual volume to meet the user-required target response performance and to present this solution to the user. Therefore, the user is able to improve the response performance of the problem volume by simply selecting and instructing the execution of either one or multiple solutions from among the presented solutions.

Furthermore, the user is also able to change a presented solution as needed and execute same in accordance with budget constraints without having to use the presented solution as-is. For example, pool volumes 45 may be added to the pool 401 in numbers that are either slightly more or less than the presented solution.

### Example 1

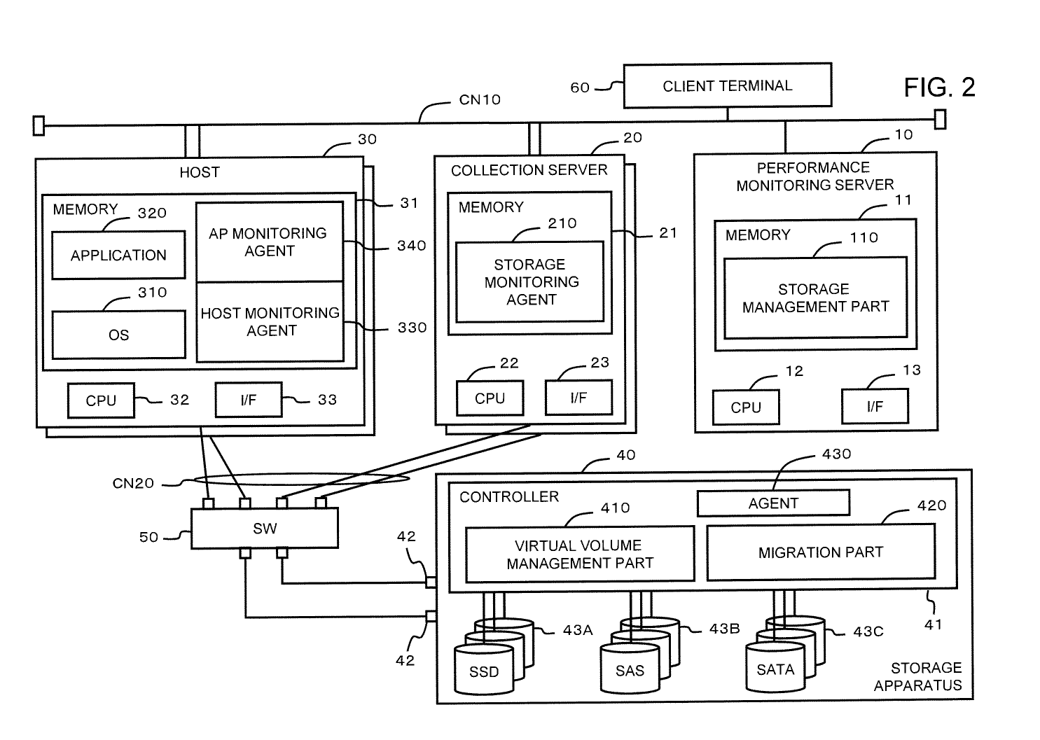

FIG. 2 is a schematic diagram showing the overall configuration of the computer system. The computer system shown in FIG. 2, for example, comprises one or more performance monitoring servers 10, one or more information collection servers 20, one or more hosts 30, one or more storage apparatuses 40, one or more switches 50, and one or more client terminals 60.

The performance monitoring server 10, for example, is a computer comprising a memory 11, a microprocessor (CPU in the drawing) 12, and a communication interface (I/F in the drawing) 13. The memory 11 stores a prescribed computer program for realizing the storage management part 110.

The performance monitoring server 10 is coupled to a management communication network CN10 via the communication interface 13. The performance monitoring server 10 is coupled to the respective hosts 30, the respective information collection servers 20, and the client terminal 60 via the management communication network CN10. The performance monitoring server 10 collects information from the respective hosts 30 and the respective information collection servers 20 via the management communication network CN10. In addition, the performance monitoring server 10 exchanges information with the client terminal 60 via the management communication network CN10.

The information collection server 20 is a computer for collecting information from the storage apparatus 40, and sending the collected information to the performance monitoring server 10. The information collection server 20, for example, comprises a memory 21, a microprocessor 22, and a communication interface 23.

The memory 21 stores a storage monitoring agent 210. The storage monitoring agent 210 is a computer program for collecting information from the storage apparatus 40 and sending this information to the storage management part 110. The information collection server 20 is coupled to the management communication network CN10 and an I/O communication network CN20 via the communication interface 23. To be precise, the communication interface for the communication network CN10 is separate from the communication interface for the communication network CN20, but in FIG. 2, these interfaces are shown as a single communication interface 23.

The management communication network CN10, for example, can be configured as either a LAN (Local Area Network) or the Internet. The I/O communication network CN20, for example, can be configured as either a FC-SAN (Fibre Channel-Storage Area Network) or an IP-SAN (Internet Protocol-SAN). Furthermore, the configuration may be such that the management communication network CN10 is abandoned, and management information is exchanged using the I/O communication network CN20.

The host 30 uses a storage apparatus 40—provided virtual volume 400 and provides an application service to a client computer not shown in the drawing. The host 30, for example, is a computer comprising a memory 31, a microprocessor 32, and a communication interface 33.

The memory 31 stores an operating system (OS in the drawing) 310, an application program (either application or AP in the drawings) 320, a host monitoring agent 330, and an application monitoring agent 340.

The application program 320, for example, comprises a customer management program, a sales management program, an electronic mail management program, an image delivery program, and a power management program.

The host monitoring agent 330, for example, monitors the IOPS (I/Os per second) of the host 30. The monitoring result is sent to the performance monitoring server 10. The application monitoring agent 340, for example, monitors the IOPS and the response time related to the application program 320. The monitoring results are sent to the performance monitoring server 10.

The storage apparatus 40 provides a storage resource to the host 30. The storage apparatus 40, for example, comprises one or more controllers 41, and multiple different types of storage devices 43A, 43B, 43C. In FIG. 2, a single storage apparatus is included in the computer system. The configuration may be such that multiple storage apparatuses are disposed in the computer system instead.

The controller 41 controls the operation of the storage apparatus 40. The controller 41 comprises multiple communication ports 42 and is coupled to the communication network CN20 via the respective communication ports 42. The controller 41 is coupled to the information collection server 20 and the host 30 via the switch 50 and the communication network CN20.

The controller 41, for example, can be a computer comprising a microprocessor, a memory, and a communication interface. The memory stores a computer program for realizing a computer program for realizing a virtual volume management part 410, and a computer program for realizing a migration part 420.

The virtual volume management part 410 manages the virtual volume 400. The management of the virtual volume 400, for example, includes the creation of a virtual volume 400, the allocation and the allocation-release of a page, the addition of a pool volume 45 to the pool 401, and the elimination of a virtual volume. The virtual volume management part 410, as will be explained further below, adds a pool volume 45 of a specified size to a specified storage tier of a specified pool 401 in accordance with an instruction from the storage management part 110.

The migration part 420 controls the migration of a virtual volume 400. The migration part 420 migrates a specified virtual volume to a specified pool 401 in accordance with an instruction from the storage management part 110.

The storage devices 43A, 43B, 43C (will be called the storage device 43 when no particular distinction is made) are devices for storing data.

As a storage device 43, for example, a type of device that is capable of reading and writing data, such as a hard disk device, a semiconductor memory device, an optical disk device, a magneto-optical disk device, a magnetic tape device, and a flexible disk device, can be used.

In a case where a hard disk device is used as the storage device, for example, a FC (Fibre Channel) disk, a SCSI (Small Computer System Interface) disk, a SATA disk, an ATA (AT Attachment) disk, and a SAS (Serial Attached SCSI) disk can be used. Furthermore, for example, it is also possible to use a storage device such as a flash memory, a FeRAM (Ferroelectric Random Access Memory), a MRAM (Magnetoresistive Random Access Memory), an Ovonic Unified Memory, and a RRAM (Resistance RAM). In addition, for example, the configuration may also be such that different types of storage devices, like a flash memory device and a hard disk drive, are intermixed.

In this example, for the sake of convenience, an explanation will be given using an SSD (a flash memory device) as the relatively high-performance storage device 43A, an SAS disk as the medium-performance storage device 43B, and a SATA disk as the relatively low-performance storage device 43C.

The client terminal 60 is a computer for the user to access the performance monitoring server 10, input information to the performance monitoring server 10, and fetch information from the performance monitoring server 10. The client terminal 60, for example, can comprise a notebook-type personal computer, a tablet-type personal computer, a personal digital assistant, or a mobile telephone.

A user interface part may be disposed in the performance monitoring server 10 and the client terminal 60 may be eliminated. The user will also be able to exchange information with the performance monitoring server 10 via the user interface part. The user interface part, for example, comprises a display device, a printer, a voice synthesis output device, a voice input device, a keyboard, or a pointing device.

Furthermore, the configuration may also be such that the performance monitoring server 10 and the information collection server 20 are disposed inside a single computer. The configuration may also be such that the performance monitoring server 10 and the information collection server 20 are disposed inside the storage apparatus 40.

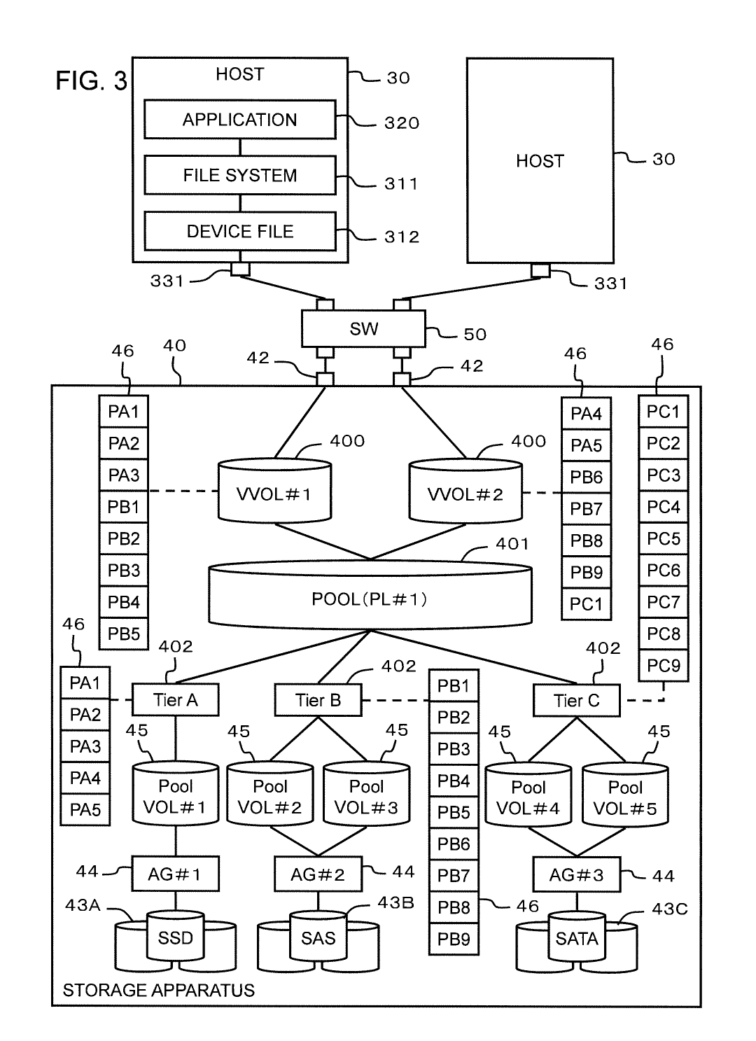

FIG. 3 is a schematic diagram showing the relationship between the virtual volume 400 and the pool 401. An application program 320 runs on the host 30. In addition, a file system 311 and a device file 312 are disposed in the host 30. The file system 311 and the device file 312 are monitoring-target resources of a host monitoring agent 330.

The file system 311 is a unit via which the operating system 310 provides data input/output services, and is for systematically managing the storage area, which becomes a data storage destination.

The device file 312 is managed by the operating system 310 as an area for storing a file in an external storage device.

The host monitoring agent 330 acquires configuration information and performance information with respect to the file system 311 and the device file 312. The application monitoring agent 340 acquires configuration information and performance information on the application program 320.

Lines connecting the resources are displayed in FIG. 3. These lines denote that an I/O dependency exists between the two resources connected by a line. For example, the application program 320 and the file system 311 are connected by a line. This line indicates that a relationship exists in which the application program 320 issues an I/O to the file system 311.

A line that connects the file system 311 with the device file 312 indicates a relationship in which the I/O load on the file system 311 constitutes a device file 312 read or write.

The device file 312 is allocated to a virtual volume 400 of the storage apparatus 40. The device file 312 may be allocated to an actual logical volume like a pool volume 45 instead. The corresponding relationship between the device file 312 and the virtual volume 400 can be acquired by the host monitoring agent 330 or the like. Furthermore, it is supposed that a logical volume created based on an actual storage device 43 is called either an actual logical volume or an actual volume.

The storage monitoring agent 210 described using FIG. 2 acquires configuration information and performance information with respect to the storage apparatus 40. The storage monitoring agent 210, for example, regards a virtual volume 400, a communication port 42, a pool 401, a storage tier 402, an array group 44, a page 46, and a pool volume 45 as monitoring-target resources, and collects information from these resources.

The array group 44 groups together actual storage areas of multiple storage devices 43. An array group 44 (AG#1) comprising high-performance storage devices 43A realizes a high-performance storage area. An array group 44 (AG#2) comprising medium-performance storage devices 43B realizes a medium-performance storage area. An array group 44 (AG#3) comprising low-performance storage devices 43C realizes a low-performance storage area.

The pool volume 45 is created by slicing physical storage areas grouped together into an array group 44 into either a fixed size or an arbitrary size. The pool volume 45 is a logical storage device. The pool volume 45 is also called an actual logical volume or an actual volume. The pool volume 45 ensures a storage area proportional to the defined capacity thereof. In this regard, the pool volume 45 differs from the virtual volume 400, for which only the capacity is initially defined and which does not comprise a storage area proportional to the defined capacity.

The storage tier 402 is a logical storage device hierarchy, which is created by type of storage device 43. The storage tier 402 comprises different types of pool volumes 45. The high-level tier 402 (Tier A) comprises a pool volume 45 (#1) derived from a high-performance storage device 43A. The mid-level tier 402 (Tier B) comprises pool volumes 45 (#2) and 45 (#3) derived from a medium-performance storage device 43B. The low-level tier 402 (Tier C) comprises pool volumes 45 (#4) and 45 (#5) derived from a low-performance storage device 43C.

Each storage tier 402 allocates an actual storage area of the pool volume 45 to a virtual volume 400 in page units. A page 46 will be explained in detail further below.

Multiple virtual volumes 400 are associated with a pool 401. The virtual volume 400 is recognized as a logical storage device as seen from the host 30 the same as an ordinary actual logical volume.

However, as described hereinabove, only the volume size of the virtual volume 400 is defined at creation; an actual storage area is not secured. When the host 30 issues a write request to an address space of the virtual volume 400, an actual storage area of the required capacity is selected from the pool 401 and allocated in order to process this write request. The actual storage area is allocated to the virtual volume 400 in units of pages 46 of a prescribed size.

In FIG. 3, multiple pages 46 (PA1, PA2, PA3, PB1, PB2, PB3, PB4, PB5) have been allocated to the one virtual volume 400 (#1). Other multiple pages (PA4, PA5, PB6, PB7, PB8, PB9, PC1) have been allocated to the other virtual volume 400 (#2).

The page 46 is a storage area that each storage tier allocates to the virtual volume 400. Data stored in a page 46, for example, moves through the respective storage tiers inside the pool 401 based on an index, such as access frequency. The access frequency, for example, is either the number of I/Os per unit of time, or the last access time.

High-frequency access data is stored in a page of a high-performance storage tier. Low-frequency access data is stored in a page of a low-performance storage tier. Hereinafter, data migration may be explained as page migration. The storage management area 110 reallocates the pages 46 among the respective storage tiers based on information acquired from the storage apparatus 40.

The pool 401 comprises multiple storage tiers 402 of different performance like this. An actual storage area inside a storage tier 402 is allocated to a virtual volume 400 in page units. A page 46 of each storage tier 402 is migrated between storage tiers based on the frequency with which the data stored in this page 46 is accessed. Therefore, data having a higher access frequency is stored in a page 46 of a high-level tier, and data having a lower access frequency is stored in a page 46 of a low-level tier. For this reason, it is possible to shorten the average response time of the virtual volume 400 even when the capacity of the high-level tier is relatively low. However, as already mentioned, there is a likelihood that the characteristic features available when the system was built will be lost as a result of long years of operation.

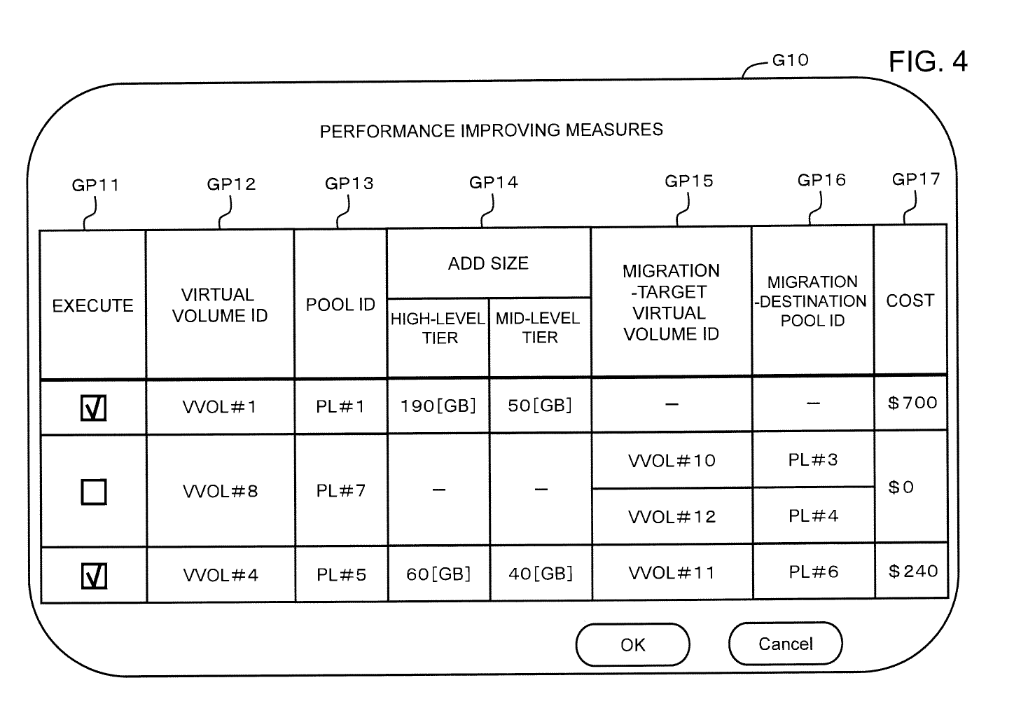

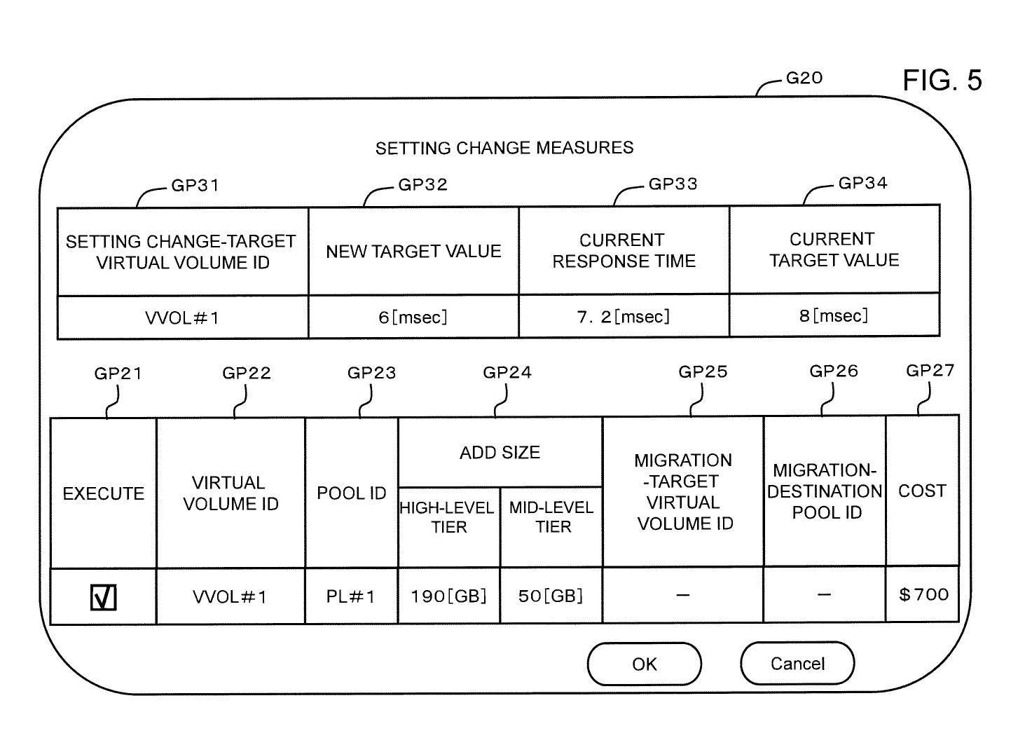

FIGS. 4 and 5 are examples of screens for providing the user with measures for improving the performance of the virtual volume 400.

FIG. 4 shows a measure presentation screen G10, which the storage management part 110 provides to the client terminal 60 in a case where a performance problem has been detected in the virtual volume 400.

The measure presentation screen G10, for example, comprises an execution selection part GP11, a virtual volume ID display part GP12, a pool ID display part GP13, an add size display part GP14, a migration-target virtual volume ID display part GP15, a migration-destination pool ID display part GP16, and a cost display part GP17.

The migration selection part GP11 is for selecting a measure to be executed from among respective measures. The user checks the execution selection part GP11 with respect to the measure he wishes to execute. The virtual volume ID display part GP12 displays identification information for identifying a virtual volume 400 (a problem volume) targeted for performance improvement. The pool ID display part GP13 displays identification information for identifying the pool 401 to which the problem volume belongs. In the identification information in the drawing, the virtual volume is displayed as “VVOL” and the pool is displayed as “PL”.

The add size display part GP14 displays the size of a new storage area (the size of a new pool volume 45) to be added to the pool 401 comprising the problem volume. The volume size to be added to the high-level tier, and the volume size to be added to the mid-level tier are displayed separately in the add size display part GP14. A volume addition to the low-level tier is not included in the add size display part GP14. This is because the addition of a pool volume 45 to the low-level tier is not useful for improving the performance of the problem volume.

The migration-target virtual volume ID display part GP15 displays identification information for identifying the virtual volume 400 to be migrated to another pool from among the other virtual volumes that belong to the pool 401 shared in common with the problem volume. The migration-destination pool ID display part GP16 displays identification information for identifying the pool 401 that will become the migration destination of the migration-target virtual volume 400.

The cost display part GP17 displays the cost required for measure execution. There is no need to prepare a new pool volume 45 in a case where a virtual volume is migrated within the same storage apparatus or between different storage apparatuses. Therefore, the cost in this case is inexpensive.

Alternatively, in a case where a new pool volume 45 is added to the pool to which the problem volume belongs, costs will be incurred in accordance with the required volume size. A high-performance storage device 43A must be used in the high-level tier. Generally speaking, a high-performance storage device 43A is more expensive than a low-performance storage device 43C. Therefore, costs will be incurred when adding a pool volume to the high-level tier and/or the mid-level tier of a pool.

In screen G10 of FIG. 4, three types of measures (solutions) are presented. A first measure is a method for adding a new pool volume 45 to a pool 401 (#1) to which a problem volume 400 (#1) belongs. The cost in this case, for example, will be US$700.00.

A second measure is a method for migrating other volumes 400 (#10) and 400 (#12) that belong to a pool 401 (#7) which is shared in common with a problem volume 400 (#8) to other pools 401 (#3) and 401 (#4). There is no cost in this case.

A third measure is a method for adding a new pool volume to a pool 401 (#5) to which a problem volume 400 (#4) belongs, and, in addition, migrating another virtual volume 400 (#11) that belongs to the pool 401 (#5) to another pool 401 (#6). The third measure combines the first measure and the second measure. A free area will be created in the pool 401 (#5) to which the problem volume 400 (#4) belongs in accordance with migrating the other virtual volume 400 (#11) to the other pool 401 (#6). Therefore, the third measure makes it possible to make the size of the pool volume 45 to be added to the pool 401 (#5) smaller than in the first measure.

The user can use the execution selection part GP11 to select any one or multiple measures from among the displayed measures. In the example of FIG. 4, the first measure for problem volume 400 (#1) and the third measure for problem volume 400 (#4) have been selected.

After selecting the problem volume for which a performance improving measure is to be implemented, the user presses the OK button. The result of the user's selection is sent from the client terminal 60 to the storage management part 110 of the performance monitoring server 10. The storage management part 110 creates the required instruction for implementing the selected measure with respect to the problem volume selected by the user and sends this instruction to the storage apparatus 40.

FIG. 5 shows a screen G20 that displays a measure required when changing the target performance of a virtual volume 400.

The screen G20 is roughly divided into two areas. A first area displays conditions related to performance (GP31 through GP34). A second area displays performance improving measures for a virtual volume for which the target performance is to be changed (GP21 through GP27).

The first area, for example, comprises a setting change-target virtual volume ID display part GP31, a new target value display part GP32, a current response time display part GP33, and a current target value display part GP34.

The display part GP31 displays identification information for identifying a virtual volume 400 for which a target performance (a target response time) is to be changed. A target performance value to be configured anew is displayed in the display part GP32 adjacent thereto. The current response performance (response time) of the target virtual volume 400 is displayed in the display part GP33. The value of the target performance currently configured with respect to the target virtual volume 400 is displayed in the last display part GP34.

The respective parts GP21 through GP 27 that comprise the second area correspond to the GP11 through GP17 shown in FIG. 4, and as such explanations of these parts will be omitted.

In a case where the new performance value desired by the user exceeds the current response performance, changing the target performance value while leaving the current configuration as-is will give rise to a problem volume. In the example of FIG. 5, the current target performance value of the virtual volume 400 (#1) is 8 msec and the current response performance value is 7.2 msec. In a case where the user changes the target performance value of the virtual volume 400 (#1) to 6 msec, it is not possible for this virtual volume to satisfy the target performance value. Therefore, the virtual volume 400 (#1) will become a problem volume as soon as the target performance value has been changed.

Consequently, the storage management part 110 provides screen G20 to the user in a case where it has been determined beforehand that a problem volume will occur. In accordance with this, it is possible to change the storage configuration to meet the target performance value change.

Next, examples of the configurations of the respective types of tables managed by the storage management part 110 will be explained. The names of the columns in the drawings to be referred to hereinbelow may be omitted for the sake of convenience. The following configurations of the tables are examples, and other information besides the information shown in the drawings may be managed. The configuration may also be such that multiple tables are combined into a single table, or a single table is divided into multiple tables.

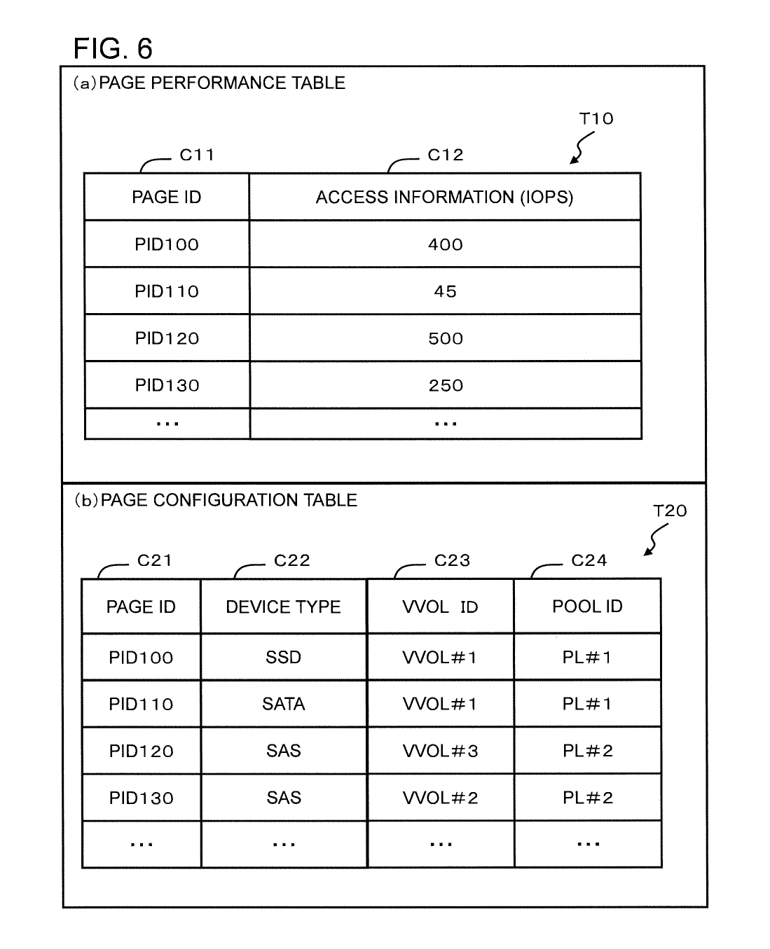

Examples of a page performance table T10 and a page configuration table T20 will be explained by referring to FIG. 6. FIG. 6(a) shows the page performance table T10. FIG. 6(b) shows the page configuration table T20.

The page performance table T10 manages access information for each page 46. The page performance table T10, for example, comprises a page ID column C11 and an access information column C12. Information for identifying each page 46 is stored in the page ID column C11. Access information for each page is stored in the access information column C12. In FIG. 6(a), the average number of I/Os per unit of time (IOPS) is managed as the access information. The configuration may also be such that a last access time is managed either instead of or together with IOPS. The access information is collected by the storage monitoring agent 210 and sent to the storage management part 110. The storage management part 110 also collects other resource information via an agent and stores and manages this information in the respective tables.

The page configuration table T20 shown in FIG. 6(b) manages the configuration of each page 46. The page configuration table T20, for example, comprises a page ID column C21, a device type column C22, a virtual volume ID column C23, and a pool ID column C24.

The page ID column C21 stores information for identifying each page 46. The device type column C22 stores the type of the storage device 43 to which the page 46 corresponds. The virtual volume ID column C23 stores information for identifying a virtual volume which the page 46 has been allocated. The pool ID column C24 stores information for identifying the pool 401 in which the page 46 exists.

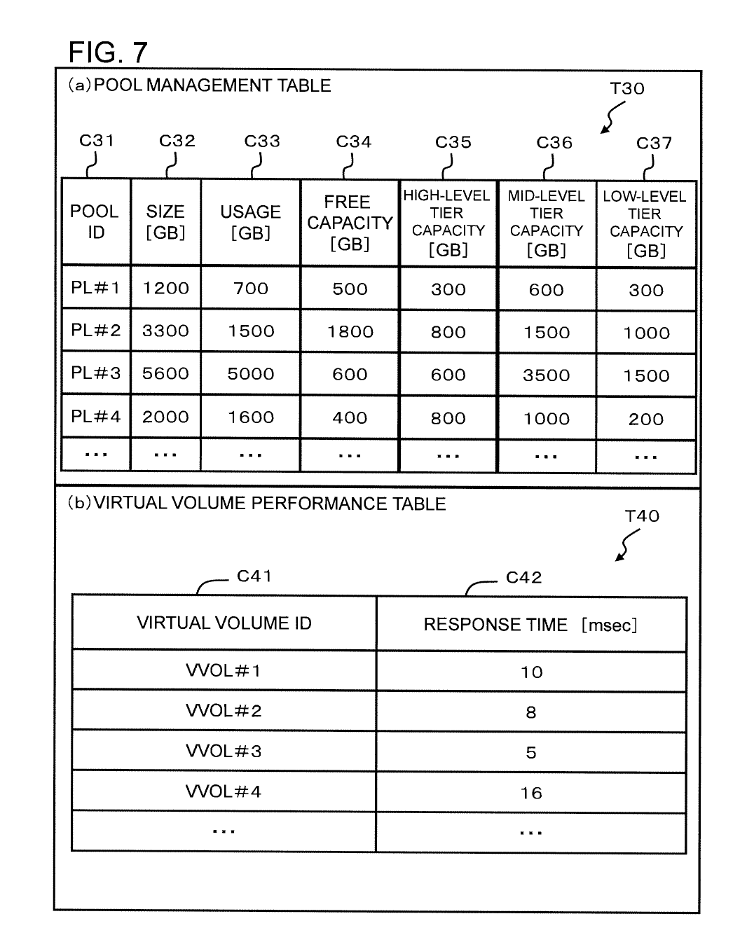

Examples of a pool management table T30 and a virtual volume performance table T40 will be explained by referring to FIG. 7.

The pool management table T30 shown in FIG. 7(a) manages the configuration of each pool 401. The pool management table T30, for example, comprises a pool ID column C31, a pool size column C32, a usage column C33, a free capacity column C34, a high-level tier capacity column C35, a mid-level tier capacity column C36, and a low-level tier capacity column C37.

The pool ID column C31 stores information for identifying each pool 401. The pool size column C32 stores the size of the pool. The usage column C33 stores the value of the used capacity. The free capacity column C34 stores the value of the unused capacity. The total of the value of C33 and the value of C34 is equivalent to the value of C32. In addition, the value of C32 is equivalent to the total value of the three values of C35 through C37, which will be explained below.

The high-level tier capacity column C35 stores the size of the high-level tier inside the pool 401. Similarly, the mid-level tier capacity column C36 stores the size of the mid-level tier inside the pool 401. The low-level tier capacity column C37 stores the size of the low-level tier inside the pool 401.

The virtual volume performance table T40 shown in FIG. 7(b) manages the response performance of the virtual volume 400. The virtual volume performance table T40, for example, comprises a virtual volume ID column C41 and a response time column C42. The virtual volume ID column C41 stores information for identifying each virtual volume 400. The response time column C42 stores the response time of the virtual volume 400.

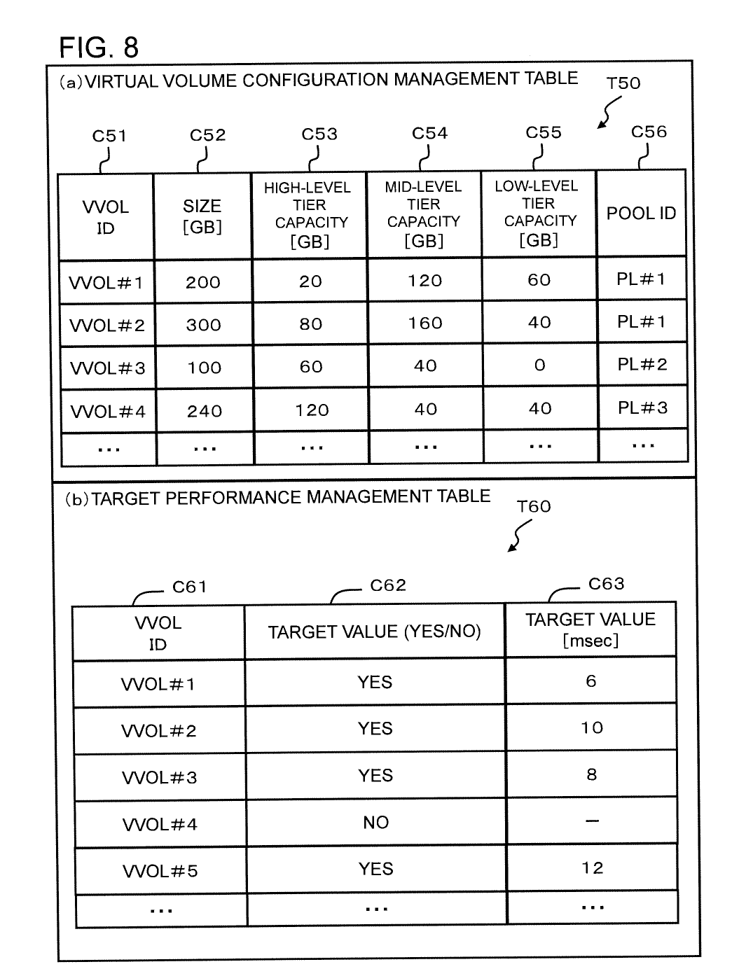

Examples of a virtual volume configuration management table T50 and a target performance management table T60 will be explained by referring to FIG. 8.

The virtual volume configuration management table T50 shown in FIG. 8(a) manages the configuration of each virtual volume 400. The virtual volume configuration management table T50, for example, comprises a virtual volume ID column C51, a volume size column C52, a high-level tier capacity column C53, a mid-level tier capacity column C54, a low-level tier capacity column C55, and a pool ID column C56.

The virtual volume ID column C51 stores information for identifying each virtual volume 400. The volume size column C52 stores the size of the virtual volume 400. The high-level tier capacity column C53 stores the size of the high-level tier inside the virtual volume 400. The mid-level tier capacity column C54 stores the size of the mid-level tier inside the virtual volume 400. The low-level tier capacity column C55 stores the size of the low-level tier inside the virtual volume 400. The pool ID column C56 stores information for identifying the pool 401 to which the virtual volume 400 corresponds.

The target performance management table T60 shown in FIG. 8(b) manages the target performance of each virtual volume 400. The target performance management table T60, for example, comprises a virtual volume ID column C61, a target value yes/no column C62, and a target value column C63.

The virtual volume ID column C61 stores information for identifying each virtual volume 400. The target value yes/no column C62 stores information denoting whether or not a target value (target performance) has been configured for the virtual volume 400. The target value column C63 stores the value of the target performance configured with respect to the virtual volume 400.

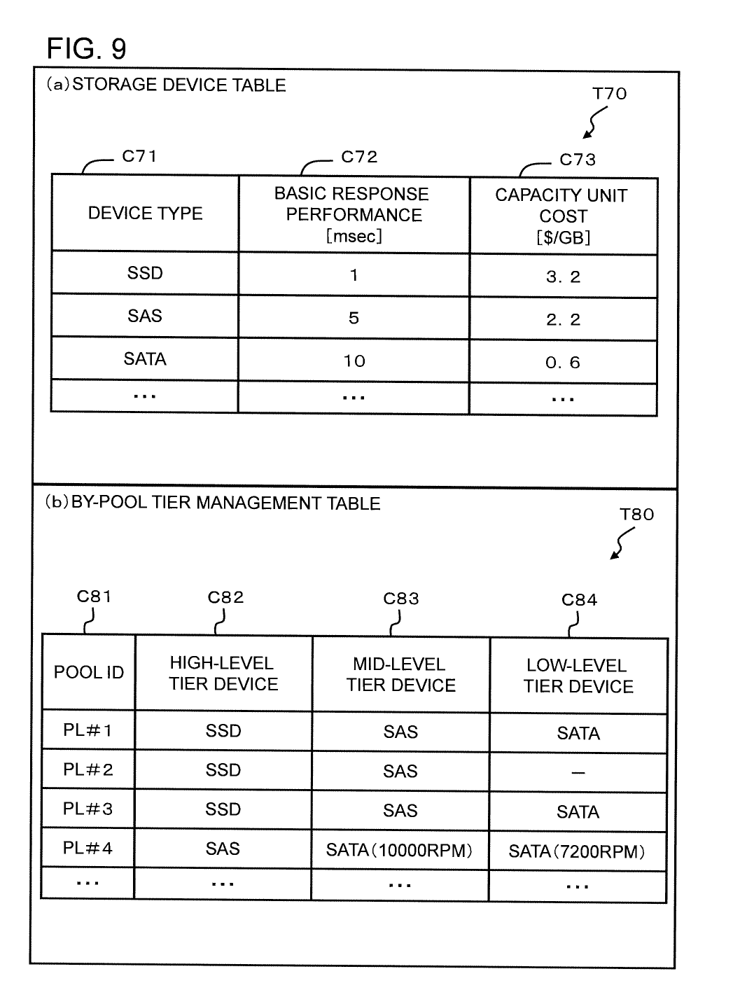

Examples of a storage device table T70 and a by-pool tier management table T80 will be explained by referring to FIG. 9.

The storage device table T70 shown in FIG. 9(a) manages information for each type of storage device. The storage device table T70, for example, comprises a device type column C71, a basic response performance column C72, and a capacity unit cost column C73.

The device type column C71 stores the type of the storage device 43. In this example, an explanation will be given of a case in which the high-performance storage device 43A, which provides a high-level tier, the medium-performance storage device 43B, which provides a mid-level tier, and the low-performance storage device 43C, which provides a low-level tier each comprises one type of storage device, that is, a case in which three types of storage devices 43 are used.

Furthermore, the present invention is not limited to this, and the configuration may be such that four or more types of storage devices are used or may be such that two types of storage devices are used.

The basic response performance column C72 stores the value of the basic response performance (basic response time) of the storage device. The capacity unit cost column C73 stores the capacity unit cost of each type of storage device. The configuration may be such that the information of the storage device table T70 is either manually or automatically acquired from the website of the vendor who manufactured and sold the storage device 43, or may be such that the user manually registers each piece of information in the table T70.

The by-pool tier management table T80 shown in FIG. 9(b) manages information related to each tier inside each pool 401. The by-pool tier management table T80, for example, comprises a pool ID column C81, a high-level tier device column C82, a mid-level tier device column C83, and a low-level tier device column C84.

The pool ID column C81 stores information for identifying each pool 401. The high-level tier device column C82 stores the type of the storage device comprising the pool high-level tier. The mid-level tier device column C83 stores the type of the storage device comprising the pool mid-level tier. The low-level tier device column C84 stores the type of the storage device comprising the pool low-level tier. The configuration may be such that information acquired from the storage apparatus 40 is automatically registered in the table T80, or may be such that the user manually registers the information in the table T80.

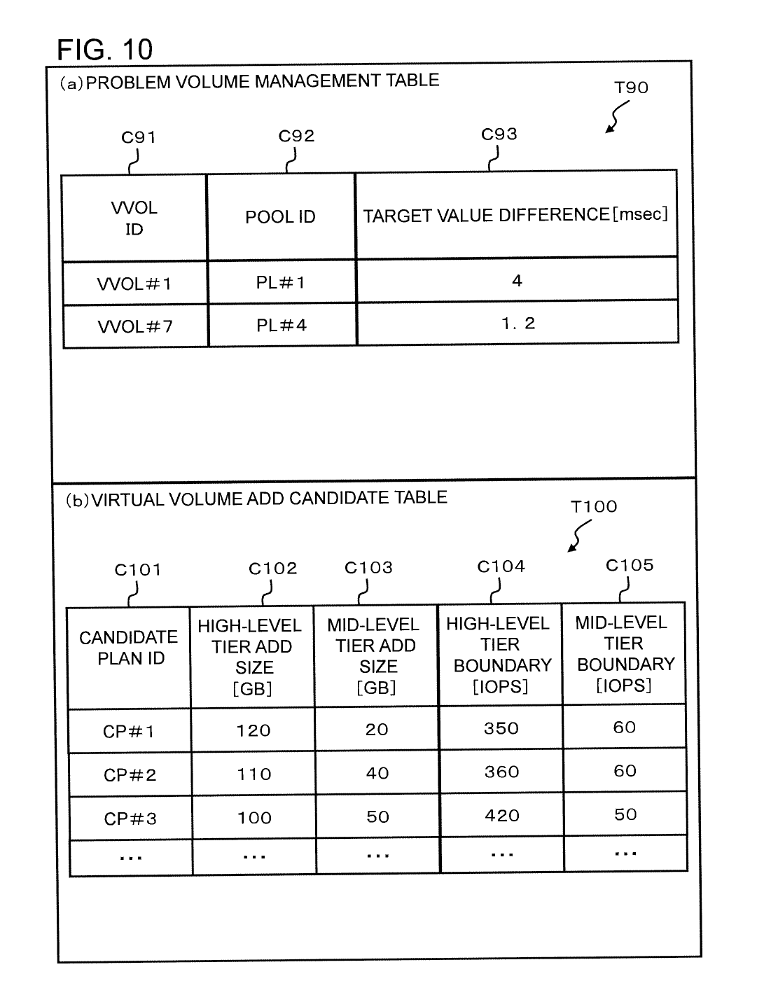

Examples of a problem volume management table T90 and a virtual volume add candidate table T100 will be explained by referring to FIG. 10.

The problem volume management table T90 shown in FIG. 10(a) manages a virtual volume in which a performance problem has occurred. The problem volume management table T90, for example, comprises a virtual volume ID column C91, a pool ID column C92, and a target value difference column C93.

The virtual volume ID column C91 stores identification information for identifying a virtual volume in which a performance problem has occurred (a problem volume). The pool ID column C92 stores information for identifying the pool 401 to which the problem volume belongs. In the target value difference column C93, the difference between the target performance value configured for the problem volume and the actual response performance value of the problem volume is stored.

The virtual volume add candidate table T100 shown in FIG. 10(b) manages a candidate plan for adding free areas to the high-level tier and the mid-level tier of the problem volume. This table T100 is created for each problem volume. The FIG. 10(b) shows a virtual volume add candidate table T100 for one problem volume.

The virtual volume add candidate table T100, for example, comprises a candidate plan ID column C101, a high-level tier add size column C102, a mid-level tier add size column C103, a high-level tier boundary column C104, and a mid-level tier boundary column C105.

The candidate plan ID column C101 stores information that identifies a candidate plan for adding size to the high-level tier and the mid-level tier of the problem volume. The high-level tier add size column C102 stores the size to be added to the high-level tier of the problem volume. The mid-level tier add size column C103 stores the size to be added to the mid-level tier of the problem volume.

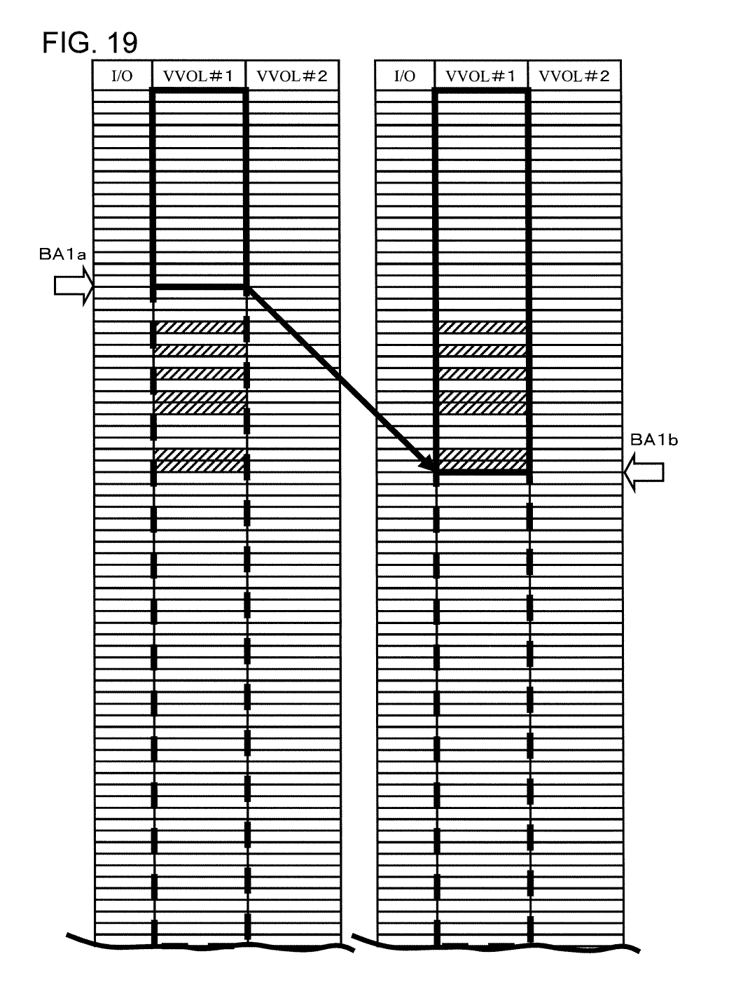

The high-level tier boundary C104 stores an access information value (IOPS) showing the boundary between the high-level tier and the mid-level tier. The mid-level tier boundary C105 stores an access information value (IOPS) showing the boundary between the mid-level tier and the low-level tier. The IOPS denoting the boundaries between the respective storage tiers will be explained further below using FIG. 19.

Simply stated, data, which is accessed more often than the value shown in the high-level tier boundary column C104, is stored in a page of the high-level tier. Data, which is accessed less often than the value shown in the mid-level tier boundary column C105, is stored in a page of the low-level tier. Data, which is accessed less often than the value shown in the high-level tier boundary column C104, but more often than the value shown in the mid-level tier boundary column C105, is stored in a page of the mid-level tier.

Of the pages belonging to the high-level tier, the access information (IOPS) of the page, which is closest to the access information of the mid-level tier page, is configured in the value of the high-level tier boundary column C104. Similarly, the access information of the page closest to the low-level tier is configured in the mid-level tier boundary column C105.

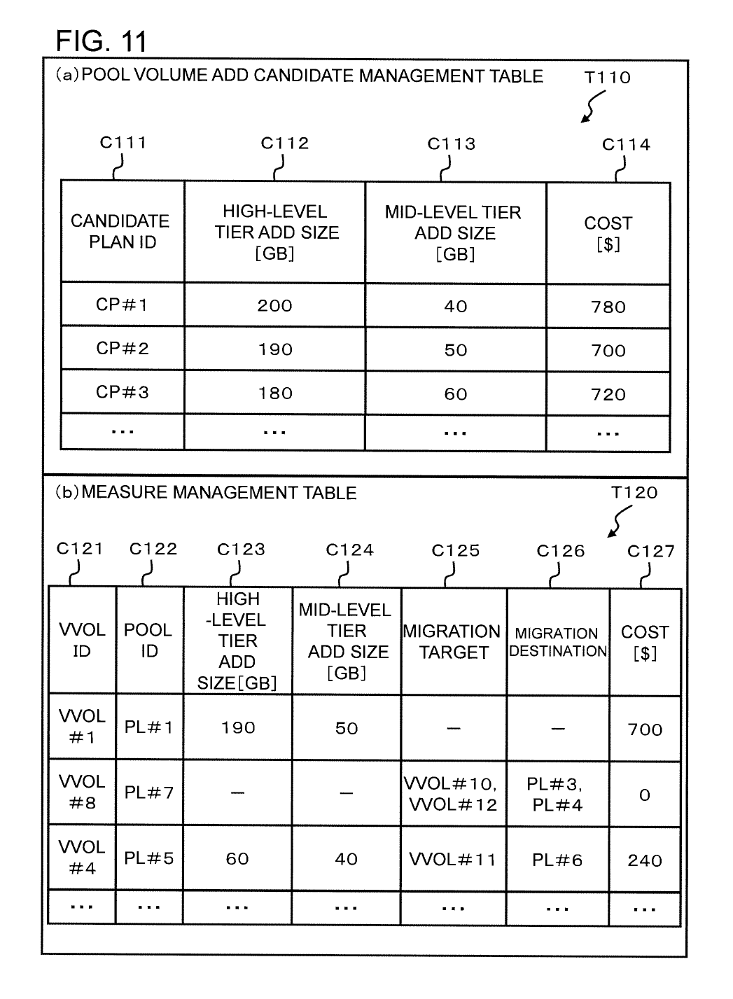

Examples of a pool volume add candidate table T110 and a measure management table T120 will be explained by referring to FIG. 11.

The pool volume add candidate table T110 shown in FIG. 11(a) manages a candidate plan for a free area to be added to the pool 401 to which a problem volume belongs. This table T110 is created for each problem volume.

The pool volume add candidate table T110, for example, comprises a candidate plan ID column C111, a high-level tier add size column C112, a mid-level tier add size column C113, and a cost column C114.

The candidate plan ID column C111 stores information for identifying a candidate plan. The high-level tier add size column C112 stores the size of an unused pool volume 45 to be added to the high-level tier of the pool 401. The mid-level tier add size column C113 stores the size of the unused pool volume 45 to be added to the mid-level tier of the pool 401. The cost column C114 stores the cost required to implement each candidate plan.

Values computed based on the values of the respective add size columns C102 and C103, and the respective boundary columns C104 and C105 of the virtual volume add candidate table T100 are stored in the high-level tier add size column C112 and the mid-level tier add size column C113.

The measure management table T120 shown in FIG. 11(b) manages a measure for solving a performance problem that has occurred in the problem volume. The measure management table T120, for example, comprises a virtual volume ID column C121, a pool ID column C122, a high-level tier add size column C123, a mid-level tier add size column C124, a migration-target volume column C125, a migration-destination pool column C126, and a cost column C127.

The virtual volume ID column C121 stores identification information for identifying a virtual volume (problem volume) that is being targeted for the implementation of a measure. The pool ID column C122 stores identification information for identifying the pool 401 to which the problem volume belongs.

The high-level tier add size column C123 stores the size of the unused pool volume 45 to be added to the high-level tier of the pool 401 comprising the problem volume (the prescribed pool). Similarly, the mid-level tier add size column C124 stores the size of the unused pool volume 45 to be added to the mid-level tier of the prescribed pool 401.

The migration-target volume column C125 stores identification information for identifying, from among other virtual volumes 400 belonging to the prescribed pool 401, the virtual volume 400 to be migrated to another pool. The migration-destination pool column C126 stores identification information for identifying the pool that will become the migration destination of the migration-target virtual volume 400. The cost column C127 stores the cost required for improving the performance of the problem volume.

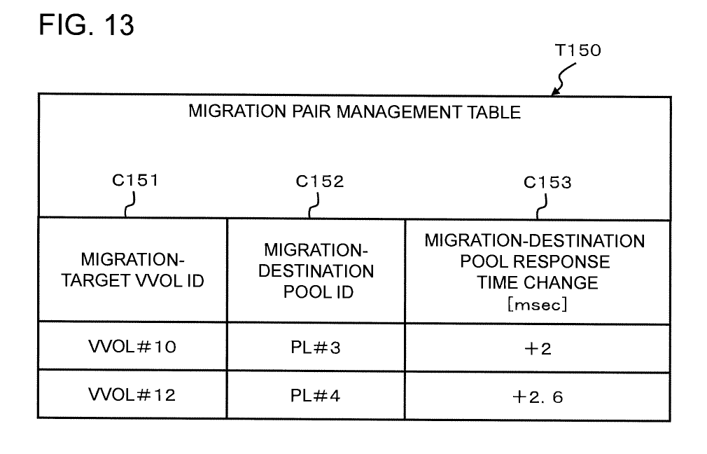

The values of the pool volume add candidate management table T110 shown in FIG. 11(a) are stored in the respective values of the high-level tier add size column C123, the mid-level tier add size column C124, and the cost column C127. The respective values of C151 and C152 of a migration pair management table T150, which will be explained using FIG. 13, are stored in the respective values of the migration-target volume column C125 and the migration-destination pool column C126.

As can be gleaned from the table T100 of FIG. 10(b), the table T110 of FIG. 11(a) and the table T120 of FIG. 11(b), multiple combined candidates of the size to be added to the high-level tier and the mid-level tier are computed, and one of these candidates is selected and registered in the table T120.

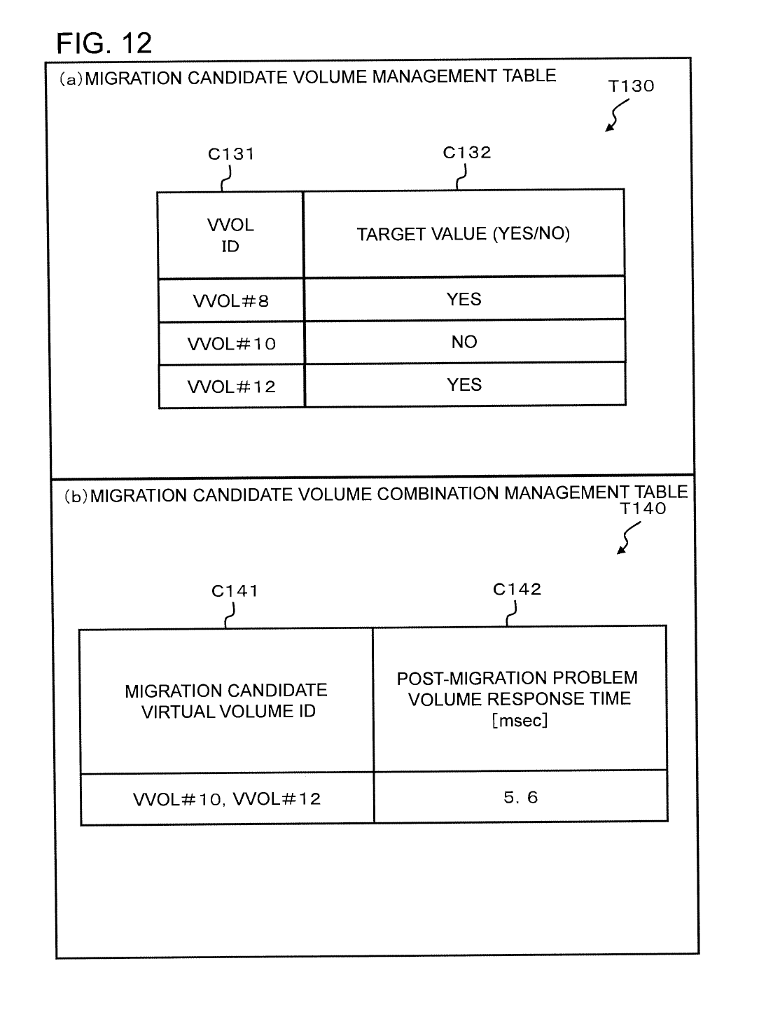

Examples of a migration candidate volume management table T130 and a migration candidate volume combination management table T140 will be explained by referring to FIG. 12.

The migration candidate volume management table T130 shown in FIG. 12(a) manages whether or not a target performance has been configured with respect to a candidate volume that could become a migration target. This table T130, for example, comprises a virtual volume ID column C131 and a target value yes/no column C132.

The virtual volume ID column C131 stores identification information for identifying a virtual volume 400 capable of becoming a migration candidate. The target value yes/no column C132 stores information denoting whether or not a target performance has been configured with respect to this virtual volume 400. As will be explained below, a virtual volume for which a target performance has not been configured is likely to be selected as a migration target because there is no need to take into account a drop in performance at the migration destination. For this reason, information as to whether or not a target performance has been configured with respect to each virtual volume 400 capable of becoming a migration target candidate is managed in the table T130.

The migration candidate volume combination management table T140 shown in FIG. 12(b) manages either one or multiple virtual volumes to be migrated to a migration destination of another pool from the migration-source prescribed pool.

The combination management table T140, for example, comprises a migration-candidate virtual volume ID column C141 and a post-migration problem volume response time column C142. The migration-candidate virtual volume ID column C141 stores identification information for identifying a migration candidate virtual volume. The response time column C142 shows the value of problem volume response performance subsequent to the migration candidate virtual volume having been migrated to the migration-destination pool. That is, column C142 stores the problem volume response performance subsequent to another virtual volume being migrated to another pool from the prescribed pool.

An example of a migration pair management table T150 will be explained by referring to FIG. 13. The migration pair management table T150 manages a migration destination and migration-destination pool response performance change with respect to one or multiple virtual volumes being migrated to another pool.

The migration pair management table T150, for example, comprises a migration-target virtual volume ID column C151, a migration-destination pool ID column C152, and a migration-destination pool response time change column C153. The virtual volume ID column C151 stores identification information for identifying a migration-target virtual volume. The migration-destination pool ID column C152 stores identification information for identifying the pool that will become the migration destination of the migration-target virtual volume. The response time change column C153 stores a change in the response performance value for the migration-destination pool.

Next, the respective processes executed by the performance monitoring server 10 will be explained. Each process is executed by the storage management part 110. Furthermore, flowcharts, which will be described hereinbelow, show overviews of the processing. A so-called person with ordinary skill in the art should be able to replace, delete or change a portion of the steps shown in the drawings, or add a new step.

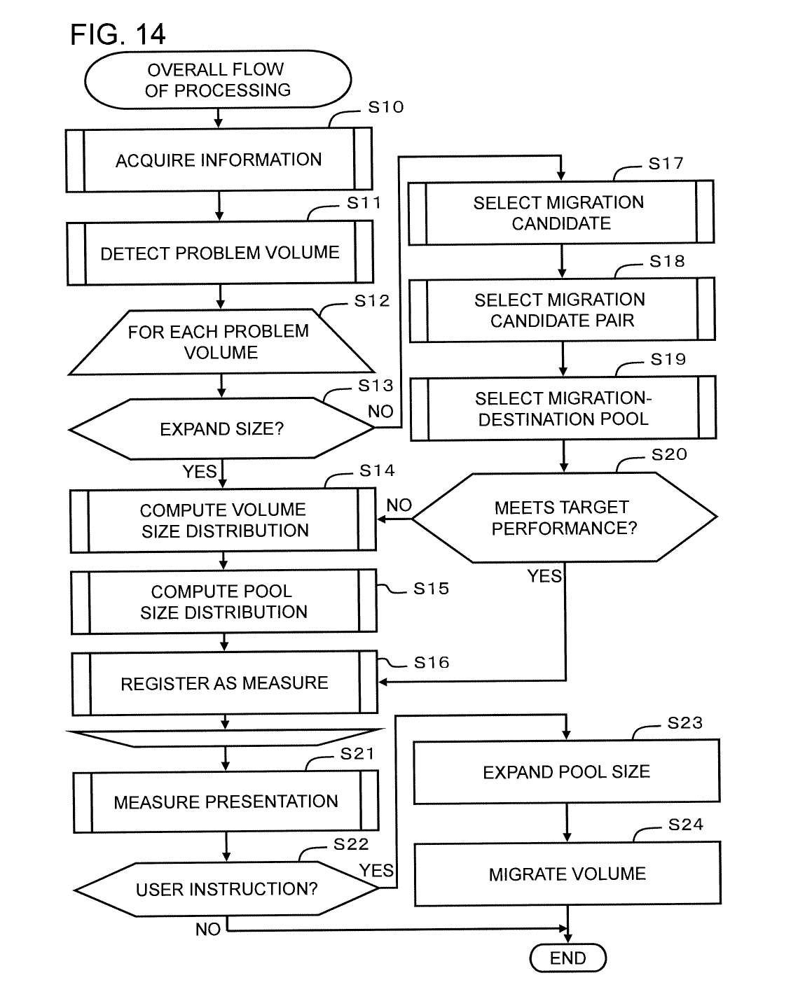

FIG. 14 is a flowchart showing the overall flow of processing for carrying out management such that the response performance of the virtual volume 400 meets the target performance. In this processing, as will be described hereinbelow, a problem volume is discovered, measures for improving the performance of the problem volume are presented, and a user-selected measure is executed.

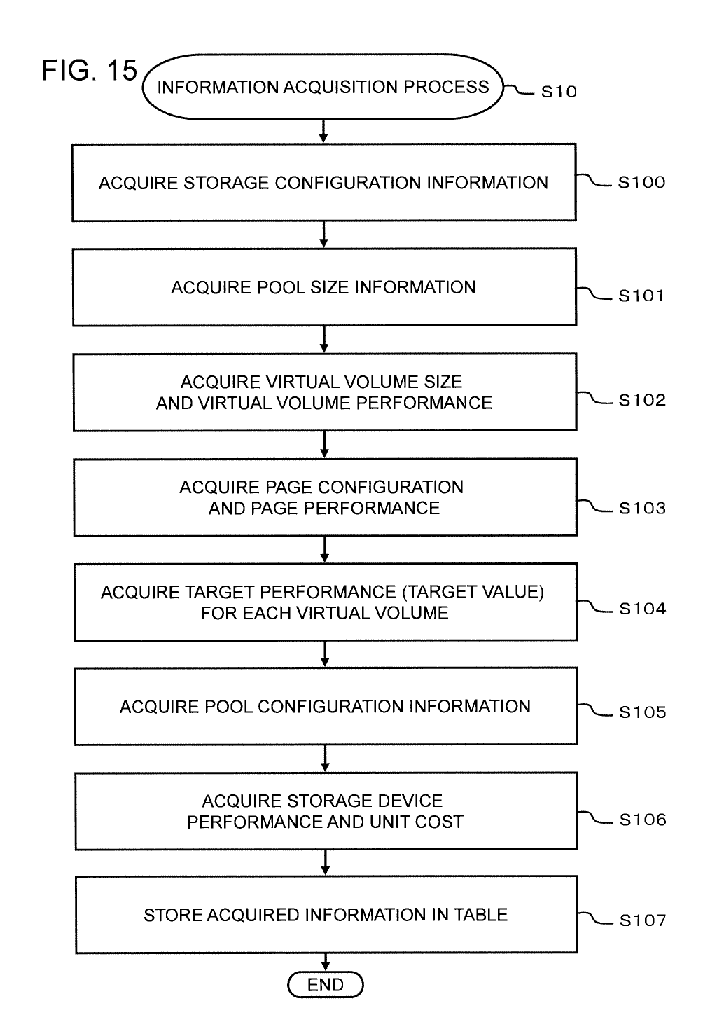

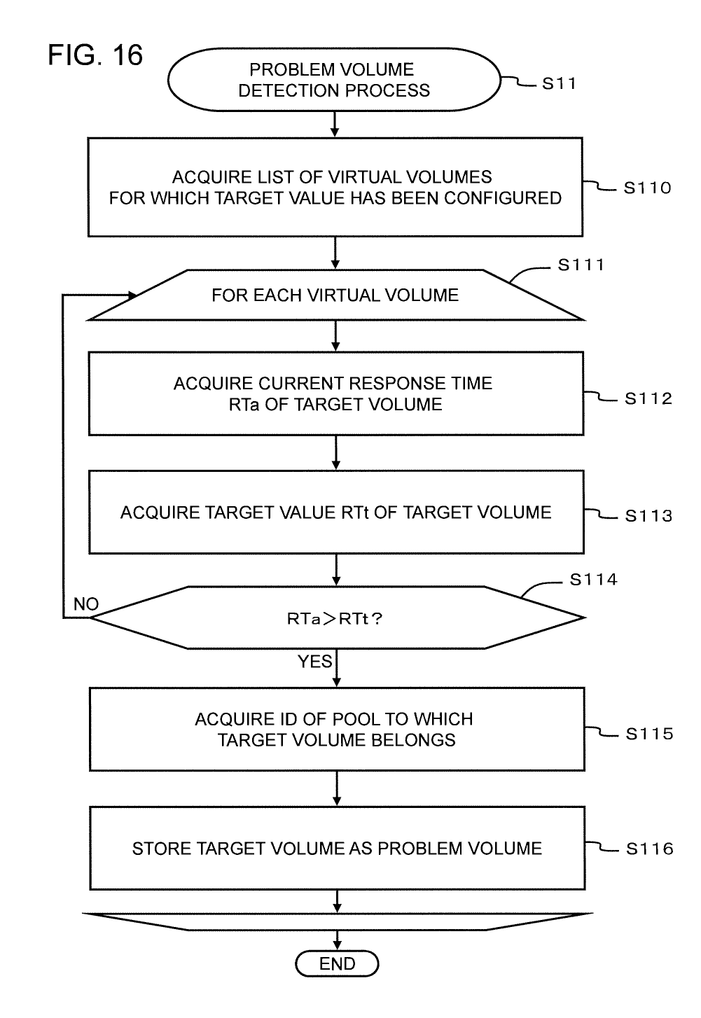

The storage management part 110 acquires various information via the storage monitoring agent 210 and so forth (S10). The information acquisition process (S10) will be explained in detail further below using FIG. 15. Next, the storage management part 110 detects a virtual volume 400 in which a performance problem has occurred (S11). The process for detecting the problem volume (S11) will be explained in detail further below using FIG. 16.

The storage management part 110 executes steps S13 through S20 described below for each problem volume detected in S11 (S12).

The storage management part 110 determines whether or not to expand the pool size to improve the performance of the problem volume (S13). In a case where an unused pool volume 45 is to be added to the pool 401 (S13: YES), the storage management part 110 computes the size of the storage area to be added to the problem volume (S14).

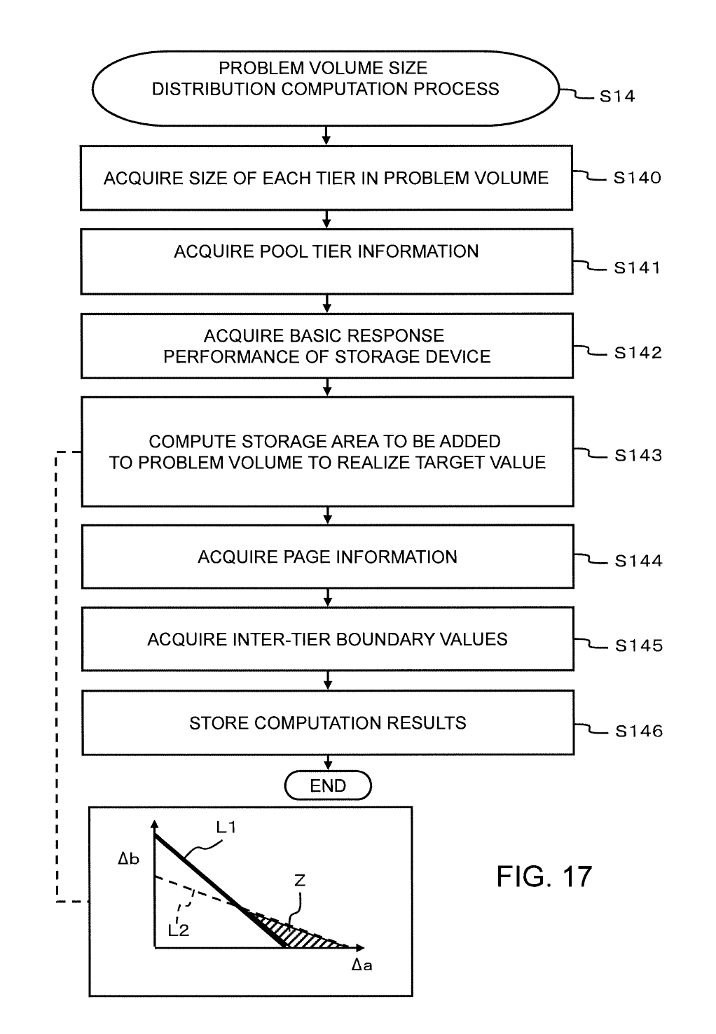

That is, the storage management part 110 computes the size of the actual storage area (the pages) to be added to the high-level tier and the mid-level tier of the problem volume. The process for computing the size allocation for each storage tier of the problem volume (S14) will be explained further below using FIG. 17.

The storage management part 110 computes the size of the unused pool volume 45 to be added to each of the high-level tier and the mid-level tier of the prescribed pool to which the problem volume belongs (S15). In this example, the explanation will focus primarily on a case in which an unused pool volume 45 is added to both the high-level tier and the mid-level tier of the pool 401. The present invention is not limited to this, and the configuration may be such that an unused pool volume 45 is only added to either one of the high-level tier or the mid-level tier.

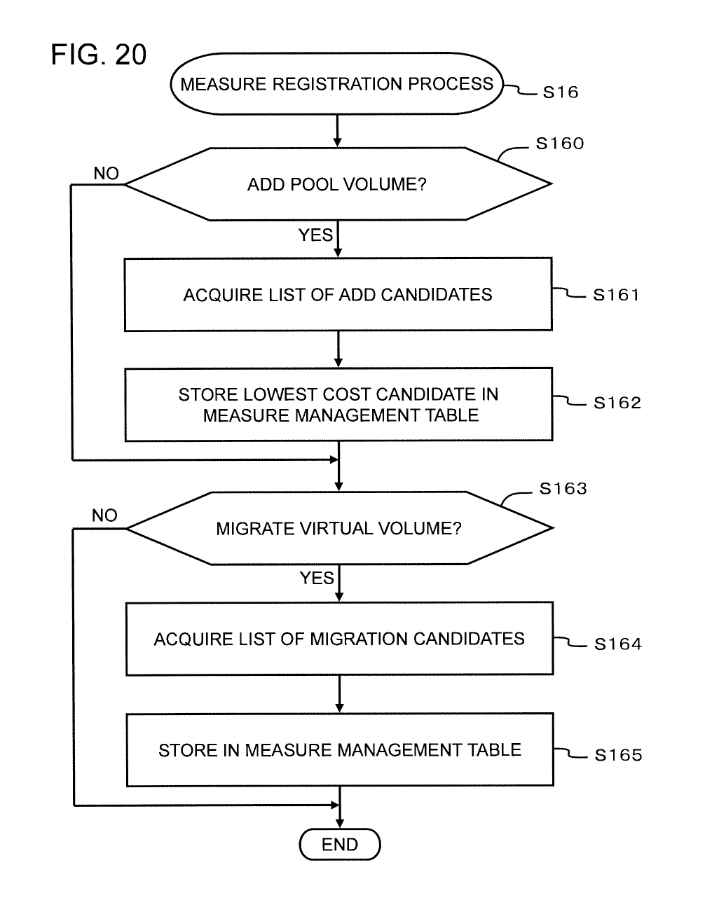

The storage management part 110 adds the pool volume 45 to the pool 401 and registers the measure for solving the problem in the measure management table T120 (S16). The process for registering the measure (S16) will be explained further below using FIG. 20.

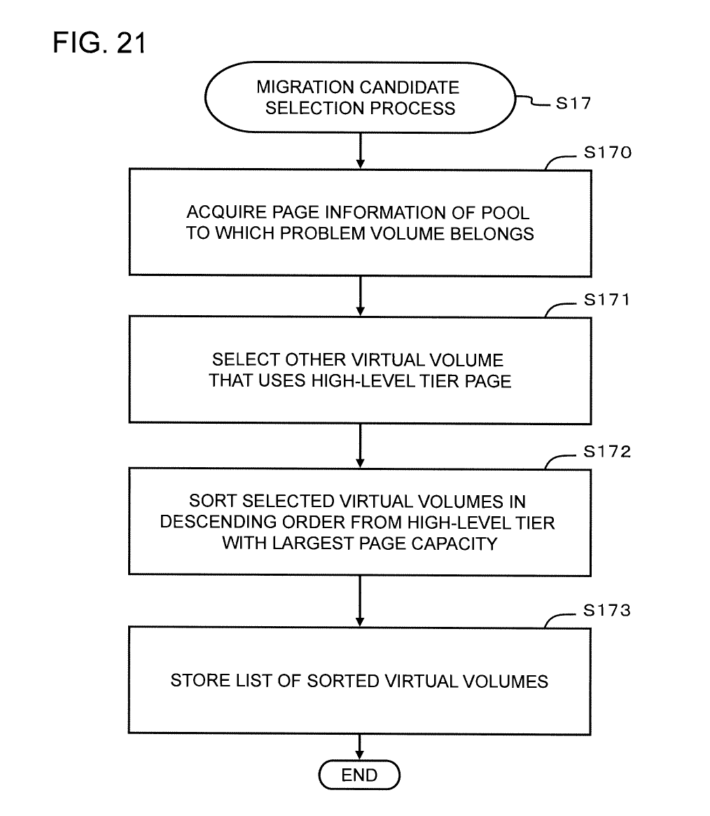

In a case where the pool size is not to be expanded (S13: NO), the storage management part 110 selects a migration candidate virtual volume (S17). The process for selecting the migration candidate volume (S17) will be explained further below using FIG. 21.

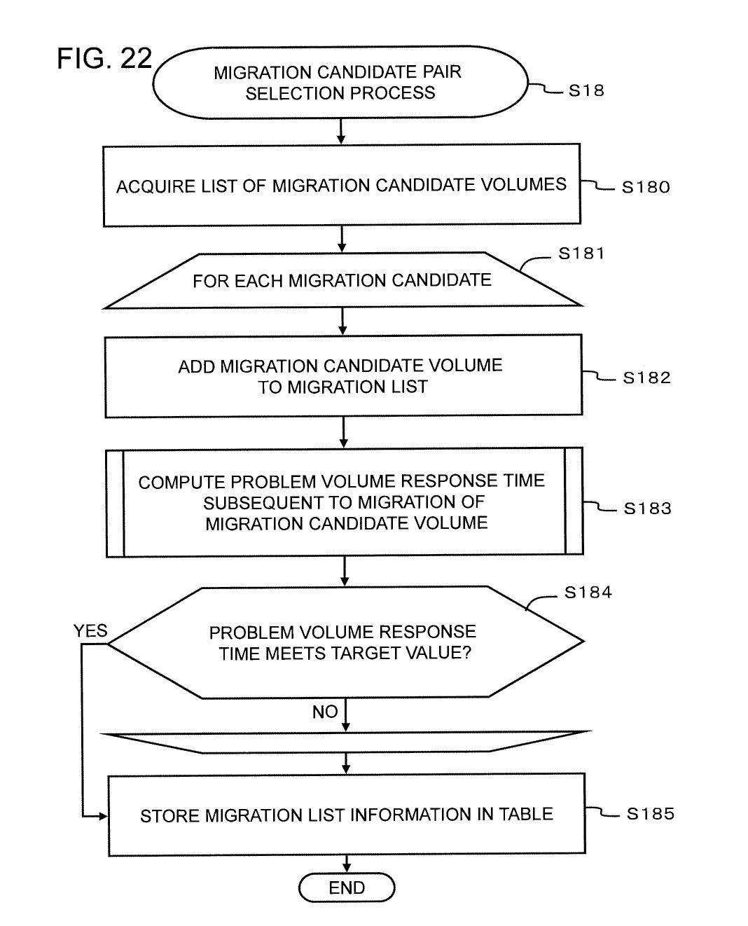

The storage management part 110 selects either one or multiple migration candidate volumes (S18). Since multiple virtual volumes may be selected as migration candidates, in this example, this processing will be called the migration candidate combination selection process. The migration candidate combination selection process (S18) will be explained further below using FIG. 22.

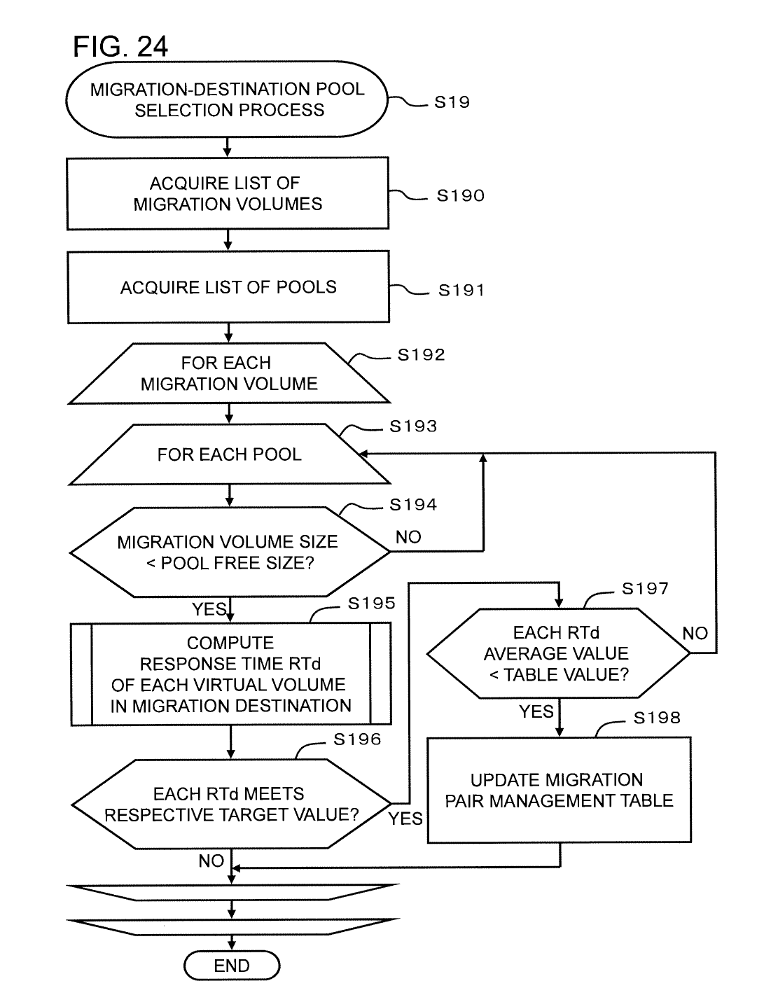

The storage management part 110 selects a migration-destination pool (S19). The process for selecting the migration-destination pool (S19) will be explained further below using FIG. 24.

The storage management part 110 determines whether or not the problem volume will satisfy the target performance by migrating either one or multiple virtual volumes from the prescribed pool in which the problem occurred to another pool (S20).

In a case where the problem in the problem volume is able to be solved by simply migrating a virtual volume (S20: YES), the storage management part 110 registers the method for migrating a virtual volume to the migration-destination pool as the measure in the table T120 (S16).

In a case where it is not possible to solve the performance problem by simply migrating a virtual volume (S20: NO), the storage management part 110 computes the size allocation of each storage tier of the problem volume (S14). That is, in a case where it is not possible to deal with the problem by simply migrating a virtual volume, the storage management part 110 also creates a measure for expanding the size of the prescribed pool (the first solution) in addition to the measure for migrating a virtual volume (the second solution).

Upon executing steps S13 through S20 for each problem volume, the storage management part 110 displays the measure registered in the table T120 on a screen of the client terminal 60 and presents this screen to the user (S21).

The storage management part 110 determines whether or not the user has selected any one or multiple measures from among the measures presented in the screen G10 (S22). In a case where the user has selected a measure (S22: YES), the storage management part 110 instructs the expansion of the pool size in accordance with the contents of this selected measure (S23) and/or instructs the migration of the virtual volume (S24).

The process by which the storage management part 110 acquires information (S10) will be explained in details by referring to FIG. 15. The storage management part 110 acquires storage apparatus 40 configuration information via the storage monitoring agent 210 (S100).

The storage management part 110, via the storage monitoring agent 210, acquires the size of each pool 401 inside the storage apparatus 40 (S101), and, in addition, acquires the size and performance of the virtual volume 400 (S102).

The storage management part 110, via the storage monitoring agent 210, acquires the configuration and performance of each page 46 (S103), and, in addition, acquires the target performance value of each virtual volume 400 (S104).

The storage management part 110, via the storage monitoring agent 210, acquires the configuration information of each pool 401 (S105), and, in addition, acquires the performance and capacity unit cost of each storage device 43 (S106).

The storage management part 110 stores the acquired various information in the page performance table T10, the page configuration table T20, the pool management table T30, the virtual volume performance table T40, the virtual volume configuration management table T50, the target performance management table T60, the storage device table T70, and the by-pool tier management table T80 (S107).

Furthermore, the basic response performance information C72 for each storage device type stored in the storage device table T70 and the capacity unit cost information C73, and the storage device information C82 through C84 for each storage tier stored in the by-pool tier management table T80 may be configured automatically in the processing shown in FIG. 15, or may be configured manually by the user.

The process by which the storage management part 110 detects a problem volume (S11) will be explained in detail by referring to FIG. 16.

The storage management part 110 acquires identification information from the target performance management table T60 with respect to a virtual volume 400 for which a target performance has been configured from among the respective virtual volumes 400, and creates a list (S110). The storage management part 110 executes steps S112 through S116 for each virtual volume included in the above-mentioned list (S111). Hereinafter, a processing-target virtual volume may be called the target volume.

The storage management part 110 acquires the current response time RTa of the target volume from the virtual volume performance table T40 based on the virtual volume ID of the target volume (S112).

The storage management part 110 acquires the target response time RTt configured with respect to the target volume from the target performance management table T60 based on the virtual volume ID of the target volume (S113).

The storage management part 110 compares the target volume response time RTa with the target response time RTt (S114). In a case where the response time RTa exceeds the target response time RTt (S114: YES), the storage management part 110 acquires the pool ID of the pool 401 to which the target volume belongs (S115). The storage management part 110 stores the virtual volume ID of the target volume, the difference between the response time RTa and the target response time RTt, and the pool ID of the pool 401 to which the target volume belongs in the problem volume management table T90 (S116).

In a case where the response time RTa is less than the target response time RTt (S114: NO), the storage management part 110 returns to S111 and evaluates the next virtual volume as a target volume.

The process by which the storage management part 110 computes the size allocation of the problem volume (S14) will be explained in detail by referring to FIG. 17.

The storage management part 110 acquires the size of each storage tier of the problem volume from the virtual volume configuration management table T50 based on the virtual volume ID acquired from the problem volume management table T90 (S140).

The storage management part 110 acquires information on each storage tier inside the pool 401 to which the problem volume belongs from the by-pool tier management table T80 (S141). Specifically, the storage management part 110 acquires information related to the type of the storage device that comprises each storage tier of this pool 401. Next, the storage management part 110 acquires the basic response performance for each storage device type from the storage device table T70 (S142).

The storage management part 110 computes the size of the storage area to be added to the problem volume based on the size of each storage tier in the problem volume and the basic response performance of the storage device 43 comprising each storage tier (S143).

Here the target response time is RTt, the high-level tier size is SA, the mid-level tier size is SB, the low-level tier size is SC, the size of the storage area (the page (The same holds true below.)) added to the high-level tier is Δa, the size of the storage area to be added to the mid-level tier is Δb, the basic response performance of the storage device 43A comprising the high-level tier is RA, the basic response performance of the storage device 43B comprising the mid-level tier is RB, and the basic response performance of the storage device 43C comprising the low-level tier is RC. The storage management part 110 computes the following Formula 1 and Formula 2.

((SA+Δa)*RA+(SB+Δb)*RB+(SC−Δa−Δb)*RC)/(SA+SB+SC)≦RTt (Formula 1)

Δa+Δb≦SC, or Δb=0 (Formula 2)

By solving for the above Formula 1 and Formula 2, it is possible to find (Δa, Δb), that is, the combination of the size Δa of the storage area to be added to the high-level tier, the size Δb of the storage area to be added to the mid-level tier. There may be a case in which the Δb is 0. That is, there may be a solution a storage area is only added to the high-level tier.

As shown at the bottom of FIG. 17, for example, the size Δa of the storage area to be added to the high-level tier is represented on a horizontal axis, and the size Δb of the storage area to be added to the mid-level tier is represented on a vertical axis. A solid line L1 is obtained from the Formula 1. The solid line L1 denotes a combination of the size of the capacity to be added to the high-level tier Δa and the size of the capacity to be added to the mid-level tier Δb that is required at a minimum to bring the problem volume response time to equal to or less than the target response time.

A broken line L2 is obtained from the Formula 2. The broken line L2 denotes a case in which a storage area is added to the high-level tier and the mid-level tier so as not to exceed the current size of the low-level tier SC. That is, adding a storage area that is larger than the current size of the low-level tier SC will result in being unable to make effective user of all of the added storage area. That is, the portion of the added storage area that exceeds the current low-level tier size SC will become surplus storage area.

Consequently, the storage management part 110 determines the (Δa, Δb) combination as a size add candidate that falls within a shaded area Z, which is a range that is equal to or greater than the solid line L1, and, in addition, equal to or less than the broken line L2 (S143).

Next, the storage management part 110 uses the page performance table T10 and the page configuration table T20 to acquire information about each page that is allocated to the problem volume (S144). The storage management part 110 arranges the respective page information in descending order from the access information with the largest value.

The storage management part 110 carries out an evaluation denoted by a Formula 3, and acquires page access information that constitutes a number of pages equivalent to the total size of (SA+Δa) (S145). This page is situated at the boundary between the high-level tier and the mid-level tier. To be precise, this page is the page that has the least access information of the pages included in the high-level tier. The access information of this page constitutes a first boundary value that divides the high-level tier from the mid-level tier.

Σ(number of pages from the top of the page information list)≧(the number of pages equivalent to the total size of SA+Δa) (Formula 3)

The storage management part 110 carries out an evaluation denoted by a Formula 4, and acquires page access information that constitutes a number of pages equivalent to the total size of (SA+Δa+SB+Δb) (S145). The access information of this page constitutes a second boundary value that divides the mid-level tier from the low-level tier.

Σ(number of pages from the top of the page information list)≧(the number of pages equivalent to the total size of SA+Δa+SB+Δb) (Formula 4)

The storage management part 110 stores the either one or multiple size add candidate values (Δa, Δb) found in S144 and the first boundary value and the second boundary value found in S145 in the virtual volume add candidate table T100 and ends the processing.

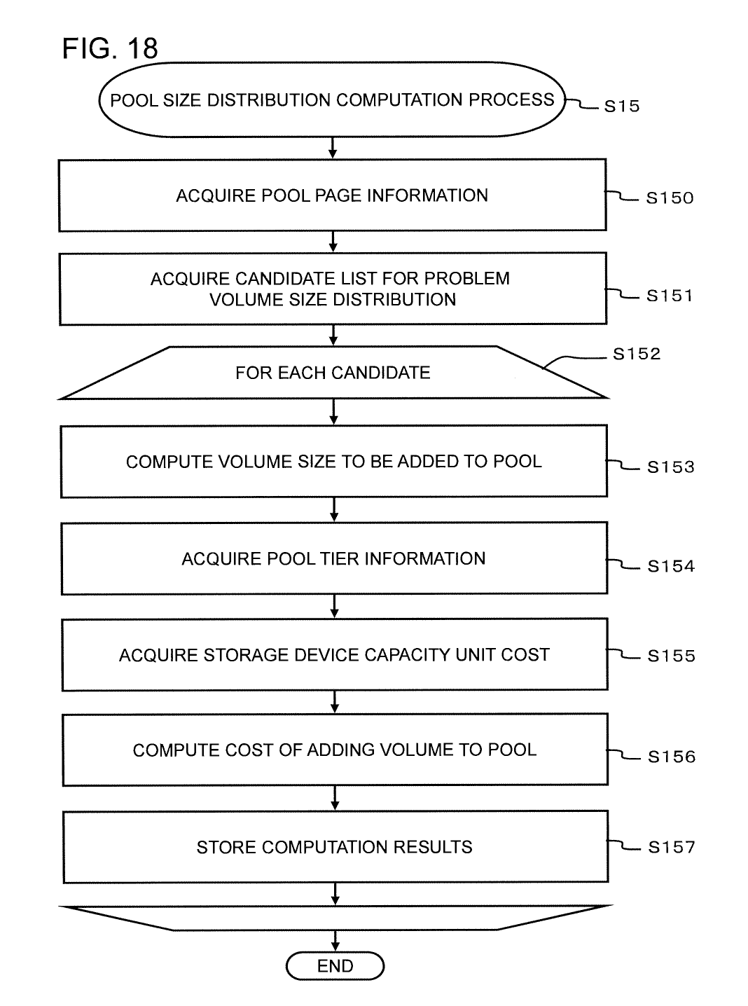

The process by which the storage management part 110 computes the size allocation of the prescribed pool (S15) will be explained in detail by referring to FIG. 18.

The storage management part 110, based on the pool ID of the prescribed pool to which a problem volume belongs, creates a list of information with respect to the pages included in the prescribed pool by using the pool management table T30 and the page performance table T10 (S150). The page information list (will also be called the page list) is arranged in descending order from the access information with the largest value.

The storage management part 110 uses the virtual volume add candidate table T100 to acquire a list of candidate information for adding a storage area to the problem volume (S151). The storage management part 110 executes steps S153 through S157 with respect to each piece of add candidate information (S152).

The storage management part 110, based on the add candidate information, computes the type and size of the pool volume 45 to be added to the prescribed pool (S153). The size of the storage area to be added, for example, is computed as follows.

First, the storage management part 110 acquires from the add candidate information both an access information value (first boundary value) that constitutes the boundary between the high-level tier and the mid-level tier, and an access information value (second boundary value) that constitutes the boundary between the mid-level tier and the low-level tier (S153).

The storage management part 110 detects a page corresponding to each boundary value (will also be called a boundary page) from the page list. The storage management part 110 counts the number of pages from the top of the page list to the detected boundary page.

Σ(number of pages from page at top of page list to first boundary value page) (Formula 5)

The storage management part 110 computes from the number of pages computed in accordance with the above Formula 5 the size required for the high-level tier.

In addition, the storage management part 110 computes the size required for the mid-level tier from the number of pages computed in accordance with a Formula 6 below.

Σ(number of pages from page at top of page list to second boundary value page)−Σ(number of pages from page at top of page list to first boundary value page) (Formula 6)

The storage management part 110, based on the pool ID of the prescribed pool, acquires the size of each storage tier from the pool management table T30 (S153). The storage management part 110 computes the size of the pool volume 45 to be added to the high-level tier by subtracting the current size from the computed required size of the high-level tier. Similarly, the storage management part 110 computes the size of the pool volume 45 to be added to the mid-level tier by subtracting the current size from the computed required size of the mid-level tier.

The storage management part 110 uses the by-pool tier management table T80 based on the pool ID of the prescribed pool to acquire the types of the storage devices 43 comprising each storage tier of the prescribed pool (S154). The storage management part 110 acquires from the storage device table T70 the capacity unit cost for each type of storage device 43 (S155).

The storage management part 110, as shown in a Formula 7 below, computes the cost required to adjust the size of each storage tier in the prescribed pool based on the size of the pool volume to be added to the high-level tier and the mid-level tier, and the capacity unit cost of the storage devices 43 comprising the high-level tier and the mid-level tier (S156).

Cost=(size to be added to high-level tier*capacity unit cost of storage device of high-level tier)+(size to be added to mid-level tier*capacity unit cost of storage device of mid-level tier) (Formula 7)

The storage management part 110 stores the size of the pool volume to be added to both the high-level tier and the mid-level tier and the required cost in the pool volume add candidate management table T110 (S157).

FIG. 19 shows how to expand the size of the high-level tier. The left side of FIG. 19 shows a state prior to expanding the size. The right side of FIG. 19 shows the state after expanding the size. It is assumed that a performance problem has occurred in the virtual volume (VVOL #1). BA1a denotes the first boundary value prior to size expansion. BA1b denotes the first boundary value after size expansion. The area enclosed within the thick solid lines denotes the high-level tier. The area enclosed within the broken lines denotes the mid-level tier. In FIG. 19, the low-level tier has been omitted.

As shown in the left side of FIG. 19, prior to the size expansion, data of prescribed pages indicated by the shaded areas is arranged in the mid-level tier. As shown in the right side of FIG. 19, the data of the prescribed pages indicated by the shaded areas is arranged in the high-level tier when the size of the high-level tier is expanded by adding a storage area (a pool volume) of the high-level tier.

Since the prescribed pages are included in the high-level tier when the size of the high-level tier is expanded like this, the average response time of the problem volume (VVOL #1) is shortened. As a result, the problem related to the response performance of the problem volume is solved. Furthermore, this average response time is also shortened by expanding the size of the high-level tier of the other virtual volume (VVOL #2) that belongs to the same pool as the problem volume.

The process by which the storage management part 110 registers a measure (S16) will be explained in detail by referring to FIG. 20.

The storage management part 110 determines whether or not a measure for adding a pool volume 45 to the prescribed pool has been created (S160). Specifically, the storage management part 110 determines whether or not a candidate plan is stored in the pool volume add candidate management table T110.

In a case where one or more records (candidate plans) exist in the pool volume add candidate management table T110 (S160: YES), the storage management part 110 acquires candidate plan information from the pool volume add candidate management table T110 (S161). The storage management part 110 stores the candidate plan with the smallest required cost value of the acquired one or more candidate plans in the measure management table T120 (S162).

In a case where not even one candidate plan is stored in the pool volume add candidate management table T110 (S160: NO), the storage management part 110 skips S161 and S162, and moves to S163 described below.

The storage management part 110 determines whether or not a measure for migrating another virtual volume belonging to the prescribed pool to another pool has been created (S163). That is, the storage management part 110 determines whether or not one or more migration-target volumes are stored in the migration pair management table T150 (S163).

In a case where one or more records are stored in the migration pair management table T150 (S163: YES), the storage management part 110 acquires a list of information related to the migration-target virtual volume (will also be called migration pair information) from the migration pair management table T150 (S164). The storage management part 110 stores the acquired list in the measure management table T120 (S165), and ends this processing. In a case where a record does not exist in the migration pair management table T150 (S163: NO), this processing ends.

The process by which the storage management part 110 selects a migration candidate virtual volume (S17) will be explained in detail by referring to FIG. 21.

The storage management part 110 uses the page performance table T10 and the page configuration table T20 to create a list of pages included in the prescribed pool to which the problem volume belongs (S170). This page list is arranged in descending order from the access information with the largest value.

The storage management part 110 refers to the page list and selects a virtual volume having the most pages with an access information value that is larger than the page allocated to the problem volume (S171). The storage management part 110 creates a list of virtual volumes with large access information values. The method for selecting a virtual volume and creating a list, for example, is as follows.

First, the storage management part 110, based on the prescribed pool page information, detects a page located at the boundary between the high-level tier and the mid-level tier of the prescribed pool. The storage management part 110 acquires the access information of the detected page. It is supposed that the value of this access information is AC1.

The storage management part 110 detects, from among the pages being used by the problem volume, a page, which belongs to the mid-level tier, and, in addition, has the closest access information to the access information AC1. The storage management part 110 acquires the access information of this page. It is supposes that the value of this access information is AC2.

The storage management part 110 selects the virtual volume that is using a page comprising access information of equal to or larger than AC2 for each virtual volume belonging to the prescribed pool (S171).

The storage management part 110 selects the number of pages comprising access information of equal to or larger than the access information AC2 with respect to the selected virtual volume, and arranges the virtual volumes in descending order from the virtual volume with the largest number of pages (S172). That is, the storage management part 110, in a case where a virtual volume has been migrated from the prescribed pool to another pool, creates a list of virtual volumes such that the virtual volume in which the most free areas occur in the high-level tier is located at the top (S172).

The storage management part 110 acquires from the target performance management table T60 a target performance setting status related to the selected virtual volume, and stores this target performance setting in the migration candidate volume management table T130 together with the information of the selected virtual volume (S173).

The process by which the storage management part 110 selects a migration candidate pair (S18) will be explained in detail by referring to FIG. 22.

The storage management part 110 acquires a list of migration candidate volumes from the migration candidate volume management table T130 (S180). The migration candidate volume is a virtual volume that is a migration-target candidate. The storage management part 110 executes the following S182 through S184 with respect to each migration candidate volume listed in the above-mentioned list.

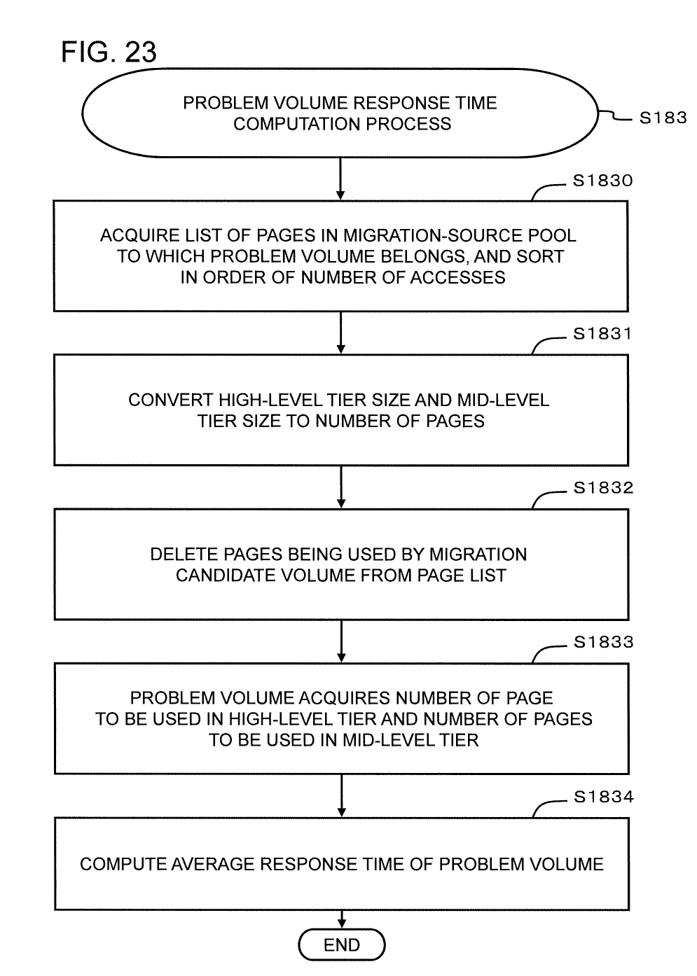

The storage management part 110 adds a migration candidate volume that constitutes a target to the migration list (S182). The storage management part 110 computes the response time of the problem volume in a case where a migration candidate volume stored in the migration list has been migrated from the prescribed pool to another pool (S183). That is, the storage management part 110 evaluates the result of a case in which the targeted migration candidate volume has been migrated to another pool. The method for estimating the response time of the problem volume will be explained further below using FIG. 23.

The storage management part 110 compares the computed response time of the problem volume (estimated value) with the target performance that has been configured with respect to the problem volume (target response time) (S184). In a case where the computed response time is less than the target response time (S184: YES), the storage management part 110 adds the information of the targeted migration candidate volume to the table T140 for managing a combination of migration candidate volumes (S185). That is, the storage management part 110 stores the information of the migration candidate volume that has been added to the migration list to the combination management table T140 (S185).

In a case where the problem volume response time (estimated value) exceeds the target response time (S184: NO), the storage management part 110 moves to the next migration candidate volume process.

The process for computing the problem volume response time (S183) will be explained in detail by referring to FIG. 23.

The storage management part 110 uses the page performance table T10 and the page configuration table T20 to create a list of page information with respect to the prescribed pool to which the problem volume belongs, and arranges this page list in descending order from the largest access information value (S1830).

The storage management part 110 uses the pool management table T30 to acquire the size of the high-level tier and the size of the mid-level tier comprising the prescribed pool, and converts these sizes into numbers of pages (S1831). It is supposed that the number of pages equivalent to the size of the high-level tier is NPA, and the number of pages equivalent to the size of the mid-level tier is NPB.

The storage management part 110 deletes all the information related to the pages allocated to the migration candidate volume from the page list acquired in S1830 and updates the page list (S1832).

Next, the storage management part 110 computes the number of allocated pages (NPVA) in the problem volume, which exists in the updated page list within the range from the top page (the page with the highest access frequency) to the NPA (S833). That is, the storage management part 110 computes the number of pages of the high-level tier that have been allocated to the problem volume. Similarly, the storage management part 110 computes the number of pages of the mid-level tier that have been allocated to the problem volume (NPVB) (S1833).

The storage management part 110 converts the computed number of pages NPVA, NPVB to a size (for example, gigabytes), and computes the problem volume estimated response time RTp on the basis of Formula 8 below (S1834).

In Formula 8, RA denotes the basic response time of the storage device 43A comprising the high-level tier, RB denotes the basic response time of the storage device 43B comprising the mid-level tier, and RC denotes the basic response time of the storage device 43C comprising the low-level tier. NPV denotes the total number of pages allocated to the problem volume.

RTp=(NPVA*RA+NPVB*RB+(NPV−NPVA−NPVB)*RC)/NPV (Formula 8)

The process by which the storage management part 110 selects a migration-destination pool (S19) will be explained in detail by referring to FIG. 24.

The storage management part 110 acquires a list of migration candidate volumes from the migration candidate volume combination management table T140 (S190). The storage management part 110 acquires a list of pools from the pool management table T30 (S191).

The storage management part 110 executes S193 through S198 with respect to each migration candidate volume listed in the migration candidate volume list (S192). In addition, the storage management part 110 executes S194 through S198 with respect to each pool 401 listed in the pool list (S193).

The storage management part 110 compares the size of the target migration candidate volume with the free size of the target migration-destination candidate pool (S194). The virtual volume size is acquired from the virtual volume configuration management table T50. The free size of the pool is acquired from the pool management table T30.

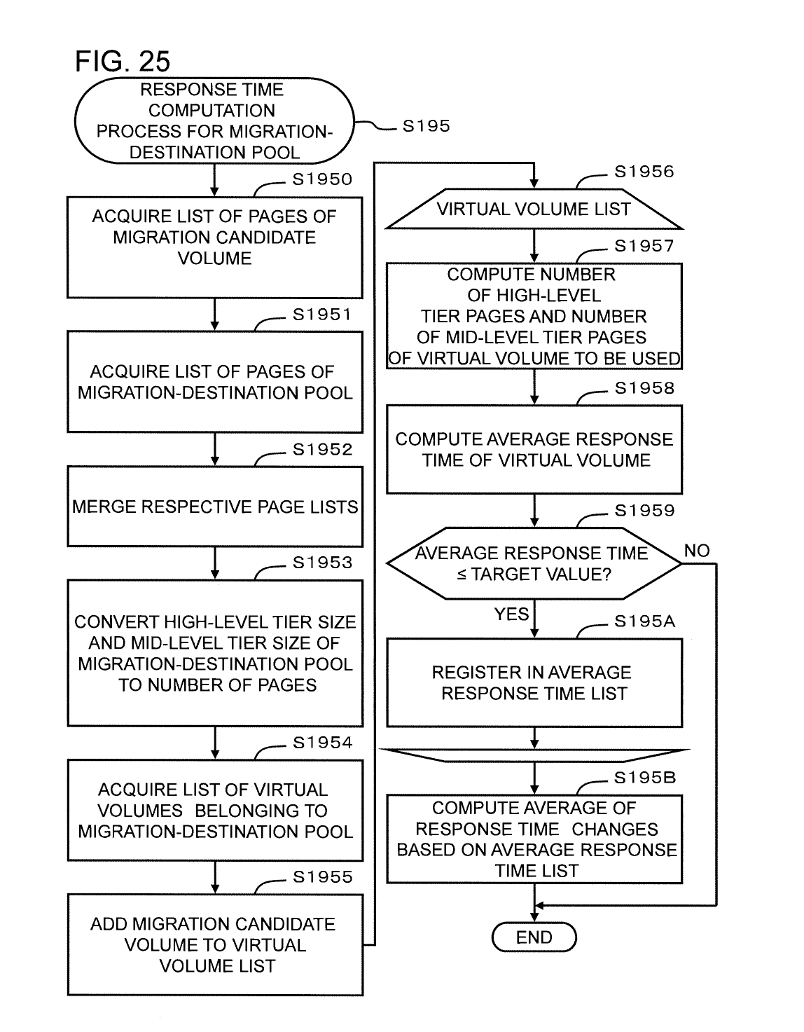

In a case where the size of the migration candidate volume is larger than the free size of the pool (S194: NO), the storage management part 110 executes 5194 with the next pool as the target pool. In a case where the size of the migration candidate volume in smaller than the free size of the pool (S194: YES), the storage management part 110 computes the response time RTd of each virtual volume that belongs to this pool (S195). The process for computing the response time RTd of the virtual volume that belongs to the migration-destination pool will be explained further below using FIG. 25.

The storage management part 110, on the basis of the result of the computation of the response time RTd, evaluates whether or not the response times RTd of the respective virtual volumes belonging to the migration-destination candidate pool are all equal to or less than the target response time (S196).

In a case where the response times RTd of the respective virtual volumes belonging to the migration-destination candidate pool are not all equal to or less than the target response time (S196: NO), the storage management part 110 returns to S193, and evaluates the next pool as the processing-target pool.

In a case where the response times RTd of the respective virtual volumes belonging to the migration-destination candidate pool are all equal to or less than the target response time (S196: YES), the storage management part 110 compares the average change time of the response time of the virtual volume belonging to the migration-destination pool with the value of the response time change column C153 of the migration pair management table T150 (S197).

In a case where the response time average change time is smaller than the value of the response time change column C153 (S197: YES), the storage management part 110 updates the contents of the migration pair management table T150 in accordance with the information of the target migration candidate volume and the information of the target migration-destination candidate pool (S198).

In a case where the response time average change time is larger than the value of the response time change column C153 of the migration pair management table T150 (S197: NO), the storage management part 110 returns to S193 and switches the processing target to the next pool.

According to the processing shown in FIG. 24, the storage management part 110 selects, with respect to each migration candidate volume, a migration-destination pool for which the change of the response time in the migration-destination pool is minimal, and stores the result of this selection in the migration pair management table T150.

The process for computing the response time of the migration-destination pool (to be more precise, the migration-destination candidate pool) (S195) will be explained in detail by referring to FIG. 25.

The storage management part 110 uses the page performance table T10 and the page configuration table T20 to create a list of page information with respect to a migration candidate volume (S1950). This page list is arranged in descending order from the access information with the largest value.

The storage management part 110 uses the page performance table T10 and the page configuration table T20 to create a list of page information with respect to a migration-destination pool (S1951). This page list is arranged in descending order from the access information with the largest value.

The storage management part 110 merges the page list created in S1950 with the page list created in S1951, and arranges the results of this merge in descending order from the access information with the largest value (S1952).

The storage management part 110 acquires the size of the high-level tier inside the pool and the size of the mid-level tier inside the pool from the pool management table T30, and converts these sizes to numbers of pages (S1953).

The storage management part 110 acquires a list of virtual volumes belonging to the migration-destination pool from the virtual volume configuration management table T50 (S1954). The storage management part 110 adds a migration candidate volume to the virtual volume list (S1955).

The storage management part 110 executes steps S1957 through S195A with respect to each virtual volume listed in the virtual volume list (S1956).

The storage management part 110 uses the page list to compute the number of pages in the high-level tier that have been allocated to the virtual volume NPVA and the number of pages in the mid-level tier that have been allocated to the virtual volume NPVB (S1957). It is supposed that the number of pages in the low-level tier that have been allocated to the virtual volume is NPVC.

The average response time RTavg of the virtual volume in the migration-destination pool subsequent to the virtual volume having been migrated from the prescribed pool to the migration-destination pool is determined from Formula 9 below (S1958). In Formula 9, it is supposed that the basic response performance of the storage device 43A comprising the high-level tier is RA, the basic response performance of the storage device 43B comprising the mid-level tier is RB, and the basic response performance of the storage device 43C comprising the low-level tier is RC.

RTavg=(NPV1*RA+NPV2*RB+NPVC*RC)/(NPVA+NPVB+NPVC) (Formula 9)

The storage management part 110 compares the average response time RTavg computed from Formula 9 with the target response time (S1959). In a case where the average response time is equal to or less than the target response time (S1959: YES), the storage management part 110 adds the average response time RTavg to the virtual volume average response time list (S195A). Thereafter, the storage management part 110 regards the next virtual volume as the target virtual volume and returns to S1956.

Alternatively, in a case where the average response time RTavg exceeds the target response time (S1959: NO), the storage management part 110 ends this processing. This is because in a case where the average response time exceeds the target response time of the virtual volume with respect to any one virtual volume belonging to the pool, this pool is not suitable as the migration-destination pool.

The storage management part 110, after carrying out the above step for each virtual volume, computes the average value of the amount of change in the average response time from the virtual volume average response time list created in S195A based on Formula 10 below (S195B) and ends this processing.

Average value of the amount of change in the average response time=Σ(average response time of post-migration virtual volume−current response time)/(number of virtual volumes) (Formula 10)

In accordance with configuring this example like this, the page allocation of each storage tier that is allocated to a virtual volume is revised and a solution is presented with respect to the virtual volume in which a performance problem occurred so that the virtual volume response performance satisfies the target performance. Since the solution can be presented to the user, the user is able to efficiently carry out a virtual volume management operation.

### Example 2

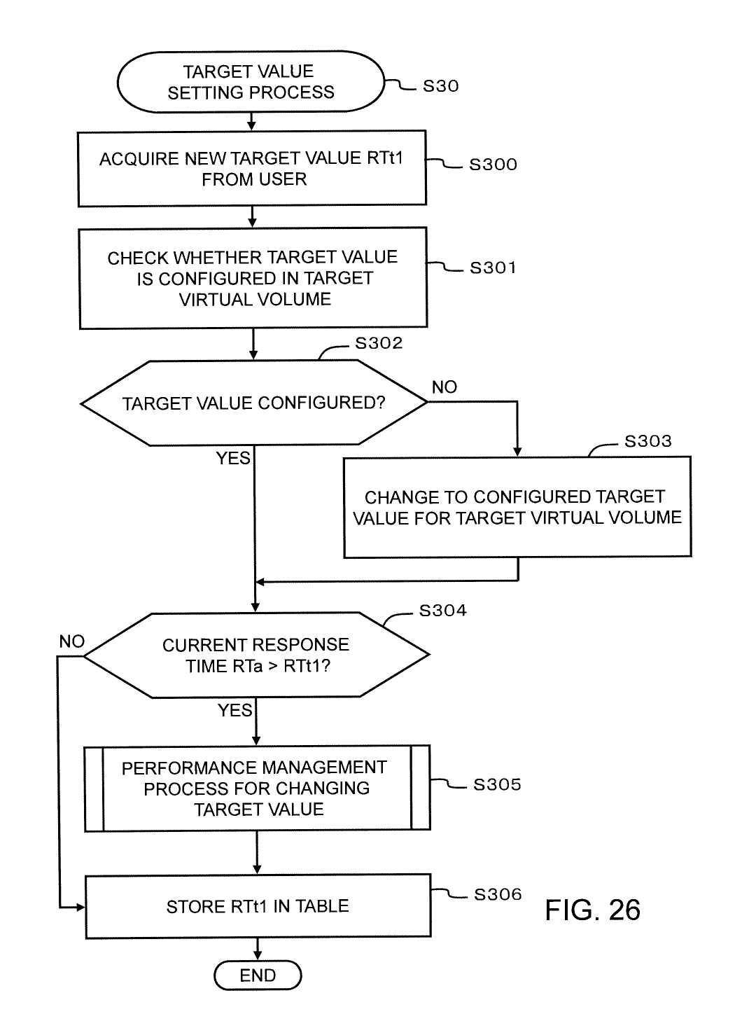

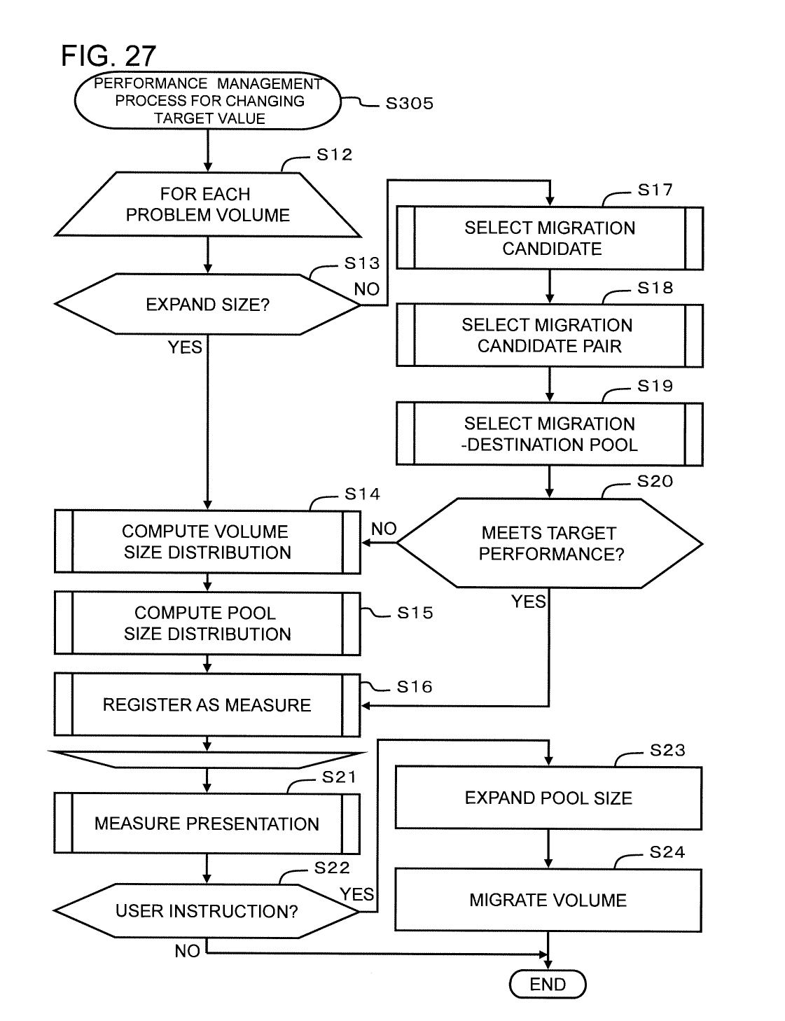

A second example will be explained by referring to FIGS. 26 and 27. This example and those that follow are equivalent to variations of the first example. Therefore, the explanations will focus on the differences with the first example.

FIG. 26 shows the processing by which the storage management part 110 either configures a target value (target response time) or changes a configured target value with respect to a virtual volume 400.

The user issues an instruction via the client terminal 60 to the storage management part 110 to change a virtual volume target value setting. The storage management part 110 acquires a new target value to be configured with respect to the virtual volume (S300).

The storage management part 110 acquires the value of the target performance management table T60 target value yes/no column C62 with respect to a target virtual volume (S301). The storage management part 110, based on the value of the column C62, determines whether or not a target value has been configured with respect to the target volume (target virtual volume) (S302).

In a case where a target value has not been configured with respect to the target volume (S302: NO), the storage management part 110 changes the value of the table T60 column C62 to “Yes” with relation to the target volume (S303).

In a case where a target value has been configured with respect to the target volume (S302: YES), the storage management part 110 compares the current response time RTa of the target volume with a new target value RTt1 inputted by the user (S304).

In a case where the current response time RTa is larger than the new target value RTt1 (S304: YES), the response time RTa must be made to equal or be less than the new target value RTt1. Consequently, the storage management part 110 executes a performance management process needed to change the target value (S305). The storage management part 110, prior to changing the target value, carries out a measure for improving the response performance of the target volume. S305 will be explained in detail further below using FIG. 27.

After executing a response performance improvement related to the target volume, the storage management part 110 stores the new target value RTt1 in the target performance management table T60 (S306). In a case where the current response time RTa is shorter than the inputted new target value RTt1 (S304: NO), it is not necessary to improve the performance of the target volume. Consequently, the storage management part 110 stores the new target value RTt1 in the target performance management table T60 (S306).

The performance management process for changing the target value (S305) will be explained in detail by referring to the flowchart of FIG. 27. The flowchart shown in FIG. 27 comprises steps S12 through S24 in common with the flowchart that was explained using FIG. 14. The flowchart shown in FIG. 27 does not comprise S10 and S11 shown in FIG. 14, but other than that does comprise all of S12 through S24. Since S12 through S24 were explained using FIG. 14, explanations of these steps will be omitted here.

By configuring this example like this, a determination is made as to whether or not the virtual volume is able to satisfy the new target value in a case where the virtual volume target value is changed. The storage management part 110, in a case where the virtual volume is unable to satisfy the new target value, presents the user with a measure for improving the performance of the virtual volume. Therefore, in this example it is also possible to heighten the efficiency of a virtual volume management operation the same as in the first example.

### Example 3

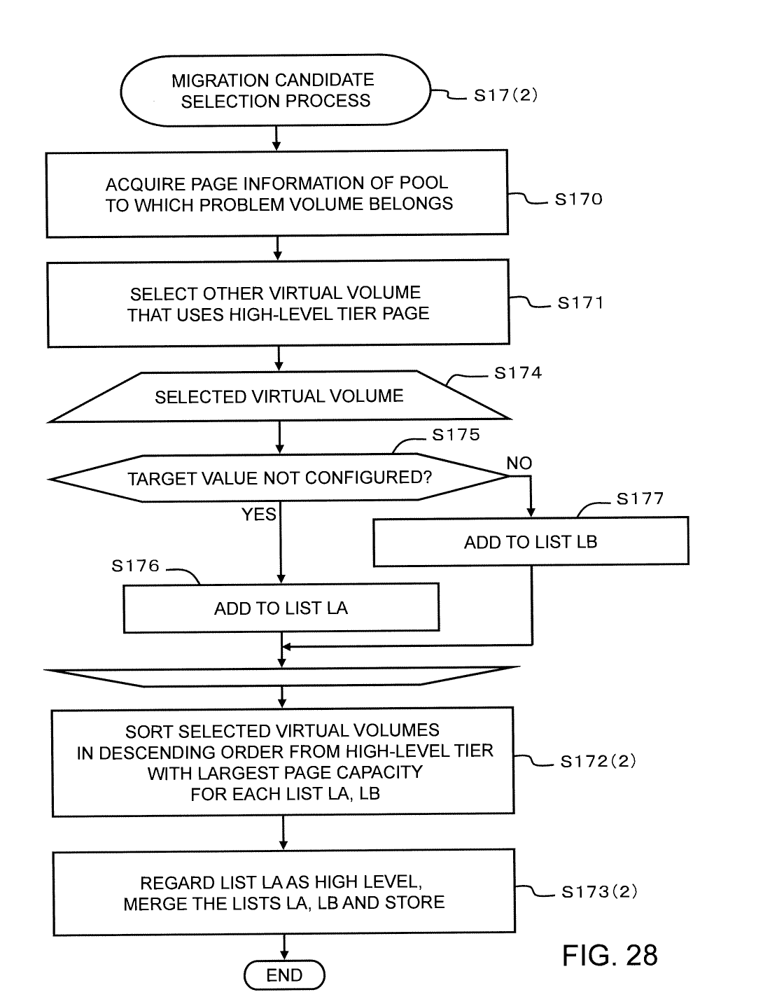

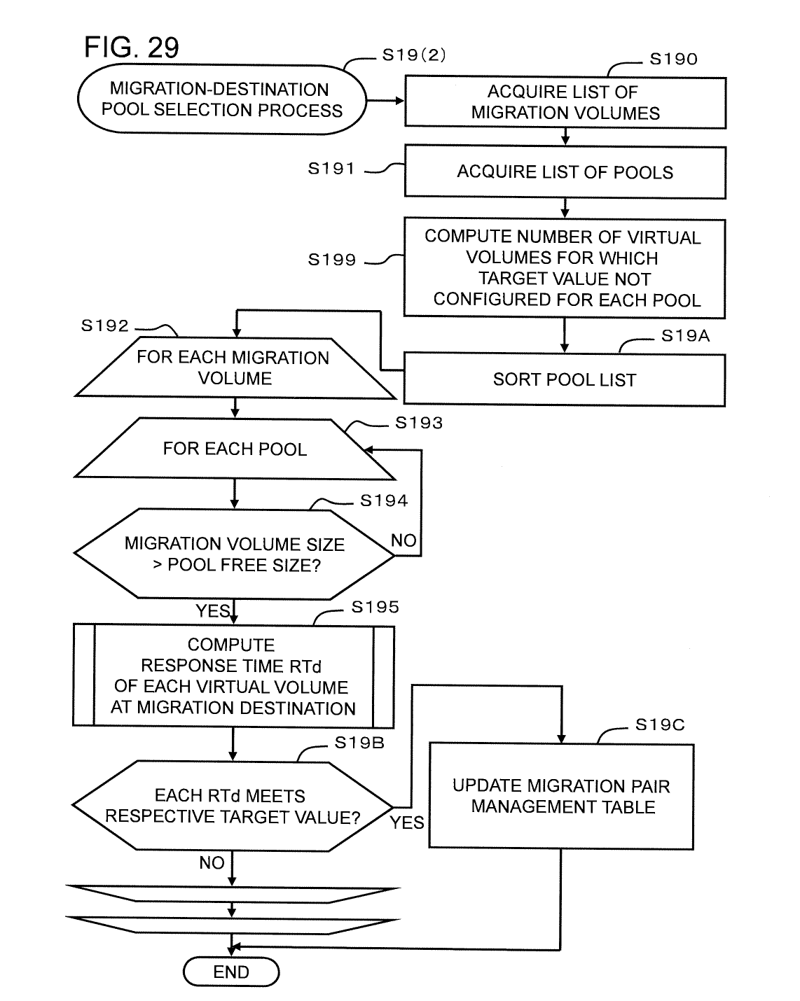

A third example will be explained by referring to FIGS. 28 and 29. In this example, a migration candidate volume and a migration-destination pool are selected by also taking into account whether or not a target value has been configured.

FIG. 28 is a flowchart showing the process by which the storage management part 110 selects a migration candidate volume (S17 (2)).

First of all, the storage management part 110 uses the page performance table T10 and the page configuration table T20 to create a list of page information with respect to the prescribed pool to which a problem volume belongs (S170). The page list is arranged in descending order from the access information (access frequency) with the largest value.

The storage management part 110 selects from the page list a virtual volume having the most pages with an access frequency that is larger than the page allocated to the problem volume and creates a virtual volume list the same as was described using FIG. 21 (S171).

The storage management part 110 executes the following S175 through S177 with respect to each virtual volume listed in the virtual volume list (S174). The storage management part 110 determines whether or not a target value has been configured with respect to the virtual volume (S175). In a case where a target value has not been configured (S175: YES), the storage management part 110 adds the virtual volume for which a target value has not been configured to a first list LA (S176). A virtual volume for which a target value has been configured (S175: NO) is added to a second list LB (S177).

After sorting each virtual volume listed in the virtual volume list into either the first list LA or the second list LB, the storage management part 110 arranges the virtual volumes in each list LA, LB in descending order from the highest access frequency (S172 (2)).

The storage management part 110 merges the virtual volumes listed in each list LA, LB such that the first list LA is on top, and stores the merge result in the migration candidate volume management table T130 (S173 (2)). This makes it possible to preferentially select a virtual volume for which a target value has not been configured as the migration candidate volume.

The process for selecting a migration-destination pool will be explained by referring to FIG. 29. The processing of FIG. 29 comprises steps S190 through S195 of the processing shown in FIG. 24. In addition, FIG. 29 comprises new steps S199 and S19A between S191 and S192. FIG. 29 also comprises S19B instead of S196, and S19C instead of S198. Consequently, the explanation will focus on the new steps.

The storage management part 110 uses the virtual volume configuration management table T50 and the target performance management table T60 to compute the number of virtual volumes for which target values have not been configured for each pool (S199).

Next, the storage management part 110, based on the computation result of S199, arranges the pool list acquired in S191 in descending order of the number of virtual volumes for which target values have not been configured (S19A).

The storage management part 110, based on the response time RTd computation results computed in accordance with steps S192 through S195, evaluates whether or not the response times RTd of the respective virtual volumes belonging to the migration-destination candidate pool are all equal to or less than the target response time (S19B).

In a case where the response times RTd of the respective virtual volumes belonging to the migration-destination candidate pool are all equal to or less than the target response time (S19B: YES), the storage management part 110 uses the information of the target migration candidate volume and the information of the target migration-destination candidate pool to update the contents of the migration pair management table T150 and ends the processing (S19C).

In accordance with this, the pool comprising the most virtual volumes for which target values have not been configured is preferentially selected as the migration-destination pool.

Configuring this example like this also achieves the same effect as the first example. In addition, since the virtual volume for which a target value has not been configured is preferentially selected as the migration candidate volume in this example, a migration candidate volume can be selected more easily than in the first example.

In addition, in this example, the pool comprising the most virtual volumes for which target values have not been configured is selected as the migration-destination pool. Therefore, a migration-destination pool can be selected more easily than in the first example. This is because it is not necessary to take into account a response performance change in the migration-destination pool with respect to a virtual volume for which a target value has not been configured.

Furthermore, the present invention is not limited to the above-described examples. A person having ordinary skill in the art will be able to make various additions and changes without departing from the scope of the present invention. For example, the technical features of the present invention described hereinabove can be put into practice by combining these features together as needed.

### REFERENCE SIGNS LIST

10 Performance monitoring server
20 Information collection server
30 Host computer
40 Storage apparatus

1. A management apparatus for managing a computer system, which comprises a host computer and a storage apparatus for providing multiple virtual volumes to the host computer,
wherein the storage apparatus comprises multiple pools comprising multiple storage tiers of respectively different performance, and is configured so as to select an actual storage area of a prescribed size from within each of the storage tiers in accordance with a write access from the host computer, and to allocate the selected actual storage area to a write-accessed virtual volume of the respective virtual volumes,
the computer system management apparatus comprising:
a problem detection part for detecting from among the respective virtual volumes a prescribed volume in which a performance problem has occurred;
a solution detection part for detecting one or more solutions for solving the performance problem by controlling allocation of each of the actual storage areas of each of the storage tiers that is allocated to the prescribed volume;
a presentation part for presenting to a user the detected one or more solutions; and
a solution execution part for executing a solution that has been selected by the user from among the presented one or more solutions.

2. A computer system management apparatus according to claim 1, further comprising:
a microprocessor;
a memory for storing a prescribed computer program that is executed by the microprocessor; and
a communication interface circuit for the microprocessor to communicate with the host computer and the storage apparatus,
wherein the problem detection part, the solution detection part, the presentation part, and the solution execution part are each realized by the microprocessor executing the prescribed computer program,
the solution detection part detects at least either one or both of a first solution or a second solution that has been prepared beforehand as the one or more solutions for solving the performance problem,
the first solution is a method by which actual storage areas belonging to a relatively high-performance storage tier are allocated in larger numbers than a current value to a prescribed volume by adding a new actual storage area to the relatively high-performance storage tier of multiple storage tiers that comprise a prescribed pool to which the prescribed volume belongs,
the second solution is a method by which actual storage areas belonging to a relatively high-performance storage tier are allocated in larger numbers than a current value to a prescribed volume by migrating another virtual volume that belongs to the prescribed pool to another pool besides the prescribed pool of the respective pools, and
the solution execution part comprises a first execution part for executing the first solution, and a second execution part for executing the second solution.

3. A computer system management apparatus according to claim 2, wherein the problem detection part detects from among the respective virtual volumes a virtual volume that is not satisfying a preconfigured target performance value as the prescribed volume in which the performance problem has occurred.

4. A computer system management apparatus according to claim 3, wherein the presentation part, in a case where the first solution is to be presented, computes and presents cost required for adding a new actual storage area to the relatively high-performance storage tier.

5. A computer system management apparatus according to claim 4, wherein, in a case where the first solution is detected, the solution detection part allocates to the prescribed volume an actual storage area belonging to the relatively high-performance storage tier such that an estimated performance value of the prescribed volume satisfies a target performance value, and
allocates to the prescribed volume an actual storage area belonging to the relatively high-performance storage tier so as not to exceed current allocation of actual storage areas belonging to a relatively low-performance storage tier of each of the storage areas of each of the storage tiers that are allocated to the prescribed volume.

6. A computer system management apparatus according to claim 5, wherein the storage apparatus migrates data that is stored in the respective actual storage areas allocated to the prescribed volume to other actual storage areas belonging to another storage tier that differs from the storage tier to which the data currently belongs by comparing the host computer access frequency to the actual storage areas with an access frequency threshold denoting a boundary for dividing the relatively high-performance storage tier and the relatively low-performance storage tier, and,
in a case where the first solution is detected, the solution detection part decreases the access frequency threshold by a prescribed amount.

7. A computer system management apparatus according to claim 2, wherein, in a case where the second solution is detected, the solution detection part allocates more than the current value of the actual storage areas belonging to the relatively high-performance storage tier by migrating the other virtual volume that uses an actual storage area belonging to the relatively high-performance storage tier comprising at least a portion of the prescribed pool to the other pool besides the prescribed pool of the respective pools.

8. A computer system management apparatus according to claim 7, wherein, in a case where the second solution is detected, the solution detection part estimates a performance value of a virtual volume belonging to the other pool in a case where the other virtual volume has been migrated to the other pool, and,
in a case where this estimated performance value is equal to or less than a target performance value configured with respect to the virtual volume belonging to the other pool, the solution detection part selects the other pool as the migration destination of the other virtual volume.

9. A computer system management apparatus according to claim 8, wherein, in a case where the second solution is detected, when multiple other virtual volumes exist, the solution detection part detects preferentially selects another volume for which a target performance value has not been configured from among the multiple other virtual volumes as a migration-target volume rather than another virtual volume for which a target performance value has been configured.

10. A computer system management apparatus according to claim 9, wherein, in a case where the second solution is detected, when multiple other pools exist, the solution detection part preferentially selects another pool comprising more virtual volumes for which a target performance value has not been configured from among the multiple other pools as the migration destination of the other virtual volume.

11. A computer system management apparatus according to claim 2, wherein, in a case where a target performance value is to be changed by the user, the problem detection part detects a change-target virtual volume as the prescribed volume when the change-target virtual volume does not satisfy the target performance value subsequent to the change.

12. A computer system management apparatus according to claim 2, wherein the multiple storage tiers comprise a high-level storage tier with highest performance, a low-level storage tier with lowest performance, and a mid-level storage tier that has performance in between that of the high-level storage tier and that of the low-level storage tier, and
the relatively high-performance storage tier comprises the high-level storage tier and the mid-level storage tier.

13. A management method for managing a computer system, which comprises a host computer and a storage apparatus for providing multiple virtual volumes to the host computer,
wherein the storage apparatus comprises multiple pools comprising multiple storage tiers of respectively different performance, and is configured so as to select an actual storage area of a prescribed size from among the respective storage tiers in accordance with a write access from the host computer, and to allocate the selected actual storage area to a write-accessed virtual volume of the respective virtual volumes,
wherein the computer system management method comprising the steps of:
acquiring information from the host computer and the storage apparatus;
detecting, based on the acquired information, a prescribed volume in which a performance problem has occurred from among the respective virtual volumes;
detecting one or more solutions for solving the performance problem by controlling allocation of each of the actual storage areas of each of the storage tiers allocated to the prescribed volume;
presenting to a user the detected one or more solutions; and
executing a solution that has been selected by the user from among the presented one or more solutions.
